(19) United States
(12) Patent Application Publication
(10) Pub. No.: US 2024/0181647 A1
(43) Pub. Date: Jun. 6, 2024

(54) SYSTEMS, METHODS, AND CONTROL MODULES FOR CONTROLLING END EFFECTORS OF ROBOT SYSTEMS

(71) Applicant: Sanctuary Cognitive Systems Corporation, Vancouver (CA)

(72) Inventors: Suzanne Gildert, Vancouver (CA); Olivia Norton, North Vancouver (CA)

(21) Appl. No.: 18/092,160

(22) Filed: Dec. 30, 2022

Related U.S. Application Data
(60) Provisional application No. 63/430,472, filed on Dec. 6, 2022.

(51) Int. Cl. B25J 9/16; B25J 13/08

(52) U.S. Cl. CPC B25J 9/1694; B25J 9/163; B25J 13/084

(57) ABSTRACT

Systems, methods, and control modules for controlling robot systems are described. A present and future state of an end effector are identified based on haptic feedback from touching an object. The end effector is transformed towards the future state. Deviations in the transformation are corrected based on further haptic feedback from touching the object. Transformation and correction of deviations are further informed by additional sensor data such as image data and/or proprioceptive data.

### TECHNICAL FIELD

The present systems, methods and control modules generally relate to controlling robot systems, and in particular relate to controlling end effectors of robot systems.

### DESCRIPTION OF THE RELATED ART

Robots are machines that may be deployed to perform work. General purpose robots (GPRs) can be deployed in a variety of different environments, to achieve a variety of objectives or perform a variety of tasks. Robots can engage, interact with, and manipulate objects in a physical environment. It is desirable for a robot to have access to sensor data to control and optimize movement of the robot with respect to objects in the physical environment.

### BRIEF SUMMARY

According to a broad aspect, the present disclosure describes a robot system comprising: an end effector; at least one haptic sensor coupled to the end effector; at least one processor; at least one non-transitory processor-readable storage medium communicatively coupled to the at least one processor, the at least one non-transitory processor-readable storage medium storing processor-executable instructions that, when executed by the at least one processor, cause the robot system to: capture, by the at least one haptic sensor, haptic data in response to the end effector touching an object; determine, by the at least one processor, a first state of the end effector based at least partially on the haptic data; determine, by the at least one processor, a second state for the end effector to engage the object based at least partially on the haptic data; determine, by the at least one processor, a first transformation trajectory for the end effector to transform the end effector from the first state to the second state; and control, by the at least one processor, the end effector to transform from the first state to the second state in accordance with the first transformation trajectory.

During transformation of the end effector in accordance with the first transformation trajectory, the processor-executable instructions may further cause the robot system to: capture, by the at least one haptic sensor, further haptic data; identify, by the at least one processor, at least one deviation by the end effector from the first transformation trajectory based on the further haptic data; and control, by the at least one processor, the end effector to correct the at least one deviation by controlling the end effector to transform towards the second state.

During transformation of the end effector in accordance with the first transformation trajectory, the processor-executable instructions may further cause the robot system to: capture, by the at least one haptic sensor, further haptic data in response to the end effector further touching the object; determine, by the at least one processor, an updated second state for the end effector to engage the object based at least partially on the further haptic data; determine, by the at least one processor, an updated first transformation trajectory for the end effector to transform the end effector to the updated second state; and control, by the at least one processor, the end effector to transform to the updated second state in accordance with the updated first transformation trajectory.

The robot system may further comprise an actuatable member coupled to the end effector; the processor-executable instructions which cause the at least one processor to determine a first state of the end effector may further cause the at least one processor to: determine the first state as a state of the end effector and the actuatable member; the processor-executable instructions which cause the at least one processor to determine a first transformation trajectory for the end effector to transform the end effector from the first state to the second state may cause the at least one processor to: determine the first transformation trajectory as a transformation trajectory for the end effector and for the actuatable member, to transform the end effector from the first state to the second state; and the processor-executable instructions which cause the at least one processor to control the end effector to transform in accordance with the first transformation trajectory may cause the at least one processor to: control the end effector and the actuatable member in accordance with the first transformation trajectory. The processor-executable instructions which cause the at least one processor to determine a second state for the end effector to engage the object may further cause the at least one processor to: determine the second state as a state of the end effector and the actuatable member for the end effector to engage the object.

The end effector may comprise a hand-shaped member. The end effector may comprise a gripper.

The processor-executable instructions which cause the at least one processor to determine a second state for the end effector to engage the object may cause the at least one processor to determine the second state as a state for the end effector to grasp the object.

The robot system may further comprise at least one image sensor, and the processor-executable instructions may further cause the robot system to, prior to capturing the haptic data by the at least one haptic sensor: capture, by the at least one image sensor, image data including a representation of the object; determine, by the at least one processor, a third state of the end effector prior to touching the object; determine, by the at least one processor, the first state for the end effector to touch the object; determine, by the at least one processor, a second transformation trajectory for the end effector to transform the end effector from the third state to the first state; and control, by the at least one processor, the end effector to transform from the third state to the first state in accordance with the second transformation trajectory. The processor-executable instructions which cause the at least one image sensor to capture image data including a representation of the object may cause the at least one image sensor to: capture image data including the representation of the object and a representation of the end effector; and the processor-executable instructions which cause the at least one processor to determine a third state of the end effector may cause the at least one processor to determine the third state of the end effector based at least partially on the image data. The processor-executable instructions which cause the at least one processor to determine the first state of the end effector may cause the at least one processor to determine the first state of the end effector based at least partially on the image data.

The robot system may further comprise at least one proprioceptive sensor; the processor-executable instructions may further cause the at least one proprioceptive sensor to capture proprioceptive data for the end effector; and the processor-executable instructions which cause the at least one processor to determine a third state of the end effector may cause the at least one processor to determine the third state of the end effector relative to the object based at least partially on the proprioceptive data. The processor-executable instructions which cause the at least one processor to determine the first state of the end effector may cause the at least one processor to determine the first state of the end effector based at least partially on the proprioceptive data.

The robot system may further comprise at least one image sensor; the processor-executable instructions may further cause the robot system to capture, by the at least one image sensor, image data including a representation of the object and a representation of the end effector; and the processor-executable instructions which cause the at least one processor to determine a first state of the end effector may cause the at least one processor to determine the first state based on the haptic data and the image data. During transformation of the end effector in accordance with the first transformation trajectory, the processor-executable instructions may further cause the robot system to: capture, by the at least one haptic sensor, further haptic data in response to the end effector further touching the object; capture, by the at least one image sensor, further image data including a further representation of the object and a further representation of the end effector; identify, by the at least one processor, at least one deviation by the end effector from the first transformation trajectory based on the further haptic data and the further image data; and control, by the at least one processor, the end effector to correct the at least one deviation. During transformation of the end effector in accordance with the first transformation trajectory, the processor-executable instructions may further cause the robot system to: capture, by the at least one haptic sensor, further haptic data in response to the end effector further touching the object; capture, by the at least one image sensor, further image data including a further representation of the object and a further representation of the end effector; determine, by the at least one processor, an updated second state for the end effector to engage the object based at least partially on the further haptic data and the further image data; determine, by the at least one processor, an updated first transformation trajectory for the end effector to transform the end effector to the updated second state; and control, by the at least one processor, the end effector to transform in accordance with the updated first transformation trajectory.

The robot system may comprise a robot body which carries the end effector, the at least one haptic sensor, the at least one processor, and the at least one non-transitory processor-readable storage medium.

The robot system may comprise a robot body and a remote device remote from the robot body; the robot body may carry the end effector and the at least one haptic sensor; and the remote device may include the at least one processor and the at least one non-transitory processor-readable storage medium.

The robot system may comprise a robot body, a remote device remote from the robot body, and a communication interface which communicatively couples the remote device and the robot body; the robot body may carry the end effector, the at least one haptic sensor, a first processor of the at least one processor, and a first non-transitory processor-readable storage medium of the at least one non-transitory processor-readable storage medium; the remote device may include a second processor of the at least one processor, and a second non-transitory processor-readable storage medium of the at least one non-transitory processor-readable storage medium; the processor-executable instructions may include first processor-executable instructions stored at the first non-transitory processor-readable storage medium that when executed cause the robot system to: capture the haptic data by the at least one haptic sensor; determine, by the first processor, the first state of the end effector; transmit, by the communication interface, state data indicating the first state from the robot body to the remote device; and control, by the first processor, the end effector to transform in accordance with the first transformation trajectory; and the processor-executable instructions may include second processor-executable instructions stored at the second non-transitory processor-readable storage medium that when executed cause the robot system to: determine, by the second processor, the second state; determine, by the second processor, the first transformation trajectory; and transmit, by the communication interface, trajectory data indicating the first transformation trajectory from the remote device to the robot body.

The first state of the end effector may comprise a first position of the end effector; the second state of the end effector may comprise a second position of the end effector different from the first position; the processor-executable instructions that cause the at least one processor to determine a first transformation trajectory to transform the end effector from the first state to the second state may cause the at least one processor to: determine a movement trajectory to move the end effector from the first position to the second position; and the processor-executable instructions that cause the at least one processor to control the end effector to transform from the first state to the second state may cause the at least one processor to: control the end effector to move the end effector from the first position to the second position in accordance with the movement trajectory.

The first state of the end effector may comprise a first orientation of the end effector; the second state of the end effector may comprise a second orientation of the end effector different from the first orientation; the processor-executable instructions that cause the at least one processor to determine a first transformation trajectory to transform the end effector from the first state to the second state may cause the at least one processor to: determine a rotation trajectory to move the end effector from the first orientation to the second orientation; and the processor-executable instructions that cause the at least one processor to control the end effector to transform from the first state to the second state may cause the at least one processor to: control the end effector to rotate the end effector from the first orientation to the second orientation in accordance with the rotation trajectory.

The first state of the end effector may comprise a first configuration of the end effector; the second state of the end effector may comprise a second configuration of the end effector different from the first configuration; the processor-executable instructions that cause the at least one processor to determine a first transformation trajectory to transform the end effector from the first state to the second state may cause the at least one processor to: determine a first actuation trajectory to actuate the end effector from the first configuration to the second configuration; and the processor-executable instructions that cause the at least one processor to control the end effector to transform from the first state to the second state may cause the at least one processor to: control the end effector to actuate the end effector from the first configuration to the second configuration in accordance with the first actuation trajectory.

According to another broad aspect, the present disclosure describes a robotic system comprising: an end effector; an end effector controller configured to control at least some of the degrees of freedom (DOFs) of the end effector; at least one haptic sensor coupled to the end effector and configured to generate haptic data in response to the end effector touching an object; and an artificial intelligence configured to provide end effector DOF control signals to the end effector controller based at least in part on the haptic data, the end effector DOF control signals being configured to reach a goal in a configuration of the end effector and the end effector DOF control signals being compensated for variations in the end effector DOFs based on the haptic data.

The end effector DOF control signals being compensated for variations in the end effector DOFs based on the haptic data may comprise: the end effector DOFs being compensated for variations between expected DOFs of the end effector as expected by the end effector controller based on control instructions the end effector controller executes to control the end effector, and actual DOFs of the end effector determined based on the haptic data.

The end effector DOF control signals being compensated for variations in the end effector DOFs based on the haptic data may comprise: the end effector DOFs being compensated for variations in the end effector DOFs caused by one or more of system errors, parameter drift, or manufacturing tolerances.

The end effector DOFs being compensated for variations between expected DOFs of the end effector as expected by the end effector controller based on control instructions the end effector controller executes to control the end effector, and actual DOFs of the end effector determined based on the haptic data may comprise: at least one compensation factor being learned by the artificial intelligence which represents consistent variations between expected DOFs of the end effector as expected by the end effector controller and actual DOFs of the end effector controller determined based on the haptic data, independent of the object; and the at least one compensation factor being applied by the artificial intelligence to compensate for variations in the end effector DOFs.

The end effector DOF control signals being compensated for variations in the end effector DOFs based on the haptic data may comprise: the end effector DOFs being compensated for variations in the end effector DOFs caused by properties of the object. The end effector DOFs being compensated for variations between expected DOFs of the end effector as expected by the end effector controller based on control instructions the end effector controller executes to control the end effector, and actual DOFs of the end effector determined based on the haptic data may comprise: a haptic model being generated by the end effector controller which represents the object, based on the haptic data; and the haptic model being applied by the artificial intelligence to compensate for variations in the end effector DOFs.

According to yet another broad aspect, the present disclosure describes a computer implemented method of operating a robot system including an end effector, at least one haptic sensor coupled to the end effector, and at least one processor, the method comprising: capturing, by the at least one haptic sensor, haptic data in response to the end effector touching an object; determining, by the at least one processor, a first state of the end effector based at least partially on the haptic data; determining, by the at least one processor, a second state for the end effector to engage the object based at least partially on the haptic data; determining, by the at least one processor, a first transformation trajectory for the end effector to transform the end effector from the first state to the second state; and control, by the at least one processor, the end effector to transform from the first state to the second state in accordance with the first transformation trajectory.

During transformation of the end effector in accordance with the first transformation trajectory, the method may further comprise: capturing, by the at least one haptic sensor, further haptic data in response to the end effector further touching the object; identifying, by the at least one processor, at least one deviation by the end effector from the first transformation trajectory based on the further haptic data; and controlling, by the at least one processor, the end effector to correct the at least one deviation by controlling the end effector to transform towards the second state.

During transformation of the end effector in accordance with the first transformation trajectory, the method may further comprise: capturing, by the at least one haptic sensor, further haptic data in response to the end effector further touching the object; determining, by the at least one processor, an updated second state for the end effector to engage the object based at least partially on the further haptic data; determining, by the at least one processor, an updated first transformation trajectory for the end effector to transform the end effector to the updated second state; and controlling, by the at least one processor, the end effector to transform to the updated second state in accordance with the updated first transformation trajectory.

The robot system may further include an actuatable member coupled to the end effector; determining a first state of the end effector may comprise: determining the first state as a state of the end effector and the actuatable member; determining a first transformation trajectory for the end effector to transform the end effector from the first state to the second state may comprise: determining the first transformation trajectory as a transformation trajectory for the end effector and for the actuatable member, to transform the end effector from the first state to the second state; and controlling the end effector to transform in accordance with the first transformation trajectory may comprise: controlling the end effector and the actuatable member in accordance with the first transformation trajectory. Determining a second state for the end effector to engage the object may comprise: determining the second state as a state of the end effector and the actuatable member for the end effector to engage the object.

Determining a second state for the end effector to engage the object may comprise: determining the second state as a state for the end effector to grasp the object.

The robot system may further comprise at least one image sensor, and the method may further comprise, prior to capturing the haptic data by the at least one haptic sensor: capturing, by the at least one image sensor, image data including a representation of the object; determining, by the at least one processor, a third state of the end effector prior to touching the object; determining, by the at least one processor, the first state for the end effector to touch the object; determining, by the at least one processor, a second transformation trajectory for the end effector to transform the end effector from the third state to the first state; and controlling, by the at least one processor, the end effector to transform from the third state to the first state in accordance with the second transformation trajectory. Capturing image data including a representation of the object may comprise: capturing image data including the representation of the object and a representation of the end effector; and determining a third state of the end effector may comprise determining the third state of the end effector based at least partially on the image data. Determining the first state of the end effector may comprise determining the first state of the end effector based at least partially on the image data.

The robot system may further comprise at least one proprioceptive sensor; the method may further comprise capturing, by the at least one proprioceptive sensor, proprioceptive data for the end effector; and determining a third state of the end effector may comprise determining the third state of the end effector relative to the object based at least partially on the proprioceptive data. Determining the first state of the end effector may comprise determining the first state of the end effector based at least partially on the proprioceptive data.

The robot system may further comprise at least one image sensor; the method may further comprise capturing, by the at least one image sensor, image data including a representation of the object and a representation of the end effector; and determining a first state of the end effector may comprise determining the first state based on the haptic data and the image data. During transformation of the end effector in accordance with the first transformation trajectory, the method may further comprise: capturing, by the at least one haptic sensor, further haptic data in response to the end effector further touching the object; capturing, by the at least one image sensor, further image data including a further representation of the object and a further representation of the end effector; identifying, by the at least one processor, at least one deviation by the end effector from the first transformation trajectory based on the further haptic data and the further image data; and controlling, by the at least one processor, the end effector to correct the at least one deviation. During transformation of the end effector in accordance with the first transformation trajectory, the method may further comprise: capturing, by the at least one haptic sensor, further haptic data in response to the end effector further touching the object; capturing, by the at least one image sensor, further image data including a further representation of the object and a further representation of the end effector; determining, by the at least one processor, an updated second state for the end effector to engage the object based at least partially on the further haptic data and the further image data; determining, by the at least one processor, an updated first transformation trajectory for the end effector to transform the end effector to the updated second state; and controlling, by the at least one processor, the end effector to transform in accordance with the updated first transformation trajectory.

The robot system may further comprise a robot body which carries the end effector, the at least one haptic sensor, and the at least one processor; capturing the haptic data may be performed by the at least one haptic sensor carried by the robot body; determining the first state of the end effector may be performed by the at least one processor carried by the robot body; determining the second state for the end effector may be performed by the at least one processor carried by the robot body; determining the first transformation trajectory may be performed by the at least one processor carried by the robot body; and controlling the end effector to transform from the first state to the second state may be performed by the at least one processor carried by the robot body.

The robot system may further comprise a robot body and a remote device remote from the robot body; the robot body may carry the end effector and the at least one haptic sensor; the remote device may include the at least one processor; capturing the haptic data may be performed by the at least one haptic sensor carried by the robot body; determining the first state of the end effector may be performed by the at least one processor included in the remote device; determining the second state for the end effector may be performed by the at least one processor included in the remote device; determining the first transformation trajectory may be performed by the at least one processor included in the remote device; and controlling the end effector to transform from the first state to the second state may be performed by the at least one processor included in the remote device.

The robot system may further comprise a robot body, a remote device remote from the robot body, and a communication interface which communicatively couples the remote device and the robot body; the robot body may carry the end effector, the at least one haptic sensor, and a first processor of the at least one processor; the remote device may include a second processor of the at least one processor; capturing the haptic data may be performed by the at least one haptic sensor carried by the robot body; determining the first state of the end effector may be performed by the first processor carried by the remote device; the method may further comprise transmitting, by the communication interface, state data indicating the first state from the robot body to the remote device; determining the second state for the end effector may be performed by the second processor included in the remote device; determining the first transformation trajectory may be performed by the second processor included in the remote device; the method may further comprise transmitting, by the communication interface, trajectory data indicating the first transformation trajectory from the remote device to the robot body; and controlling the end effector to transform from the first state to the second state may be performed by the first processor carried by the robot body.

The first state of the end effector may comprise a first position of the end effector; the second state of the end effector may comprise a second position of the end effector different from the first position; determining a first transformation trajectory to transform the end effector from the first state to the second state may comprise: determining a movement trajectory to move the end effector from the first position to the second position; and controlling the end effector to transform from the first state to the second state may comprise: controlling the end effector to move the end effector from the first position to the second position in accordance with the movement trajectory.

The first state of the end effector may comprise a first orientation of the end effector; the second state of the end effector may comprise a second orientation of the end effector different from the first orientation; determining a first transformation trajectory to transform the end effector from the first state to the second state may comprise: determining a rotation trajectory to move the end effector from the first orientation to the second orientation; and controlling the end effector to transform from the first state to the second state may comprise: controlling the end effector to rotate the end effector from the first orientation to the second orientation in accordance with the rotation trajectory.

The first state of the end effector may comprise a first configuration of the end effector; the second state of the end effector may comprise a second configuration of the end effector different from the first configuration; determining a first transformation trajectory to transform the end effector from the first state to the second state may comprise: determining a first actuation trajectory to actuate the end effector from the first configuration to the second configuration; and controlling the end effector to transform from the first state to the second state may comprise: controlling the end effector to actuate the end effector from the first configuration to the second configuration in accordance with the first actuation trajectory.

According to yet another broad aspect, the present disclosure describes a computer implemented method of operating a robotic system, the method comprising: generating, by at least one haptic sensor coupled to an end effector, haptic data in response to the end effector touching an object; generating, by an artificial intelligence, end effector DOF (degrees of freedom) control signals based at least in part on the haptic data, the end effector DOF control signals being configured to reach a goal in a configuration of the end effector, wherein generating the end effector DOF control signals includes compensating for variations in end effector DOFs based on the haptic data; providing, by the artificial intelligence, the end effector DOF control signals to an end effector controller; and controlling, by the end effector controller, at least some of the end effector DOFs based on the end effector DOF control signals.

Compensating for variations in end effector DOFs based on the haptic data may comprise: compensating, by the artificial intelligence, the end effector DOF control signals for variations between expected DOFs of the end effector as expected by the end effector controller based on control instructions the end effector controller executes to control the end effector, and actual DOFs of the end effector determined based on the haptic data.

Compensating for variations in end effector DOFs based on the haptic data may comprise: compensating for variations in the end effector DOFs caused by one or more of system errors, parameter drift, or manufacturing tolerances.

Compensating the end effector DOFs for variations between expected DOFs of the end effector as expected by the end effector controller based on control instructions the end effector controller executes to control the end effector, and actual DOFs of the end effector determined based on the haptic data, may comprise: learning, by the artificial intelligence, at least one compensation factor which represents consistent variations between expected DOFs of the end effector as expected by the end effector controller and actual DOFs of the end effector determined based on the haptic data, independent of the object; and applying, by the artificial intelligence, the at least one compensation factor to compensate for variations in the end effector DOFs.

Compensating for variations in end effector DOFs based on the haptic data may comprise: compensating the end effector DOF control signals for variations in the end effector DOFs caused by properties of the object. Compensating the end effector DOFs for variations between expected DOFs of the end effector as expected by the end effector controller based on control instructions the end effector controller executes to control the end effector, and actual DOFs of the end effector determined based on the haptic data, may comprise: generating a haptic model by the end effector controller which represents the object, based on the haptic data; and applying, by the artificial intelligence, the haptic model to compensate for variations in the end effector DOFs.

According to yet another broad aspect, the present disclosure describes a robot control module comprising at least one non-transitory processor-readable storage medium storing processor executable instructions or data that, when executed by at least one processor of a processor-based system, cause the processor-based system to: capture, by at least one haptic sensor coupled to an end effector of the processor-based system, haptic data in response to the end effector touching an object; determine, by the at least one processor, a first state of the end effector based at least partially on the haptic data; determine, by the at least one processor, a second state for the end effector to engage the object based at least partially on the haptic data; determine, by the at least one processor, a first transformation trajectory for the end effector to transform the end effector from the first state to the second state; and control, by the at least one processor, the end effector to transform from the first state to the second state in accordance with the first transformation trajectory.

During transformation of the end effector in accordance with the first transformation trajectory, the processor-executable instructions or data may further cause the processor-based system to: capture, by the at least one haptic sensor, further haptic data in response to the end effector further touching the object; identify, by the at least one processor, at least one deviation by the end effector from the first transformation trajectory based on the further haptic data; and control, by the at least one processor, the end effector to correct the at least one deviation by controlling the end effector to transform towards the second state.

During transformation of the end effector in accordance with the first transformation trajectory, the processor-executable instructions or data may further cause the processor-based system to: capture, by the at least one haptic sensor, further haptic data in response to the end effector further touching the object; determine, by the at least one processor, an updated second state for the end effector to engage the object based at least partially on the further haptic data; determine, by the at least one processor, an updated first transformation trajectory for the end effector to transform the end effector to the updated second state; and control, by the at least one processor, the end effector to transform to the updated second state in accordance with the updated first transformation trajectory.

The end effector may be coupled to an actuatable member of the processor-based system; the processor-executable instructions or data which cause the at least one processor to determine a first state of the end effector may further cause the at least one processor to: determine the first state as a state of the end effector and the actuatable member; the processor-executable instructions or data which cause the at least one processor to determine a first transformation trajectory for the end effector to transform the end effector from the first state to the second state may cause the at least one processor to: determine the first transformation trajectory as a transformation trajectory for the end effector and for the actuatable member, to transform the end effector from the first state to the second state; and the processor-executable instructions or data which cause the at least one processor to control the end effector to transform in accordance with the first transformation trajectory may cause the at least one processor to: control the end effector and the actuatable member in accordance with the first transformation trajectory. The processor-executable instructions or data which cause the at least one processor to determine a second state for the end effector to engage the object may further cause the at least one processor to: determine the second state as a state of the end effector and the actuatable member for the end effector to engage the object.

The processor-executable instructions or data which cause the at least one processor to determine a second state for the end effector to engage the object may cause the at least one processor to determine the second state as a state for the end effector to grasp the object.

The processor-executable instructions or data may further cause the processor-based system to, prior to capturing the haptic data by the at least one haptic sensor: capture, by at least one image sensor of the processor-based system, image data including a representation of the object; determine, by the at least one processor, a third state of the end effector prior to touching the object; determine, by the at least one processor, the first state for the end effector to touch the object; determine, by the at least one processor, a second transformation trajectory for the end effector to transform the end effector from the third state to the first state; and control, by the at least one processor, the end effector to transform from the third state to the first state in accordance with the second transformation trajectory. The processor-executable instructions or data which cause the at least one image sensor to capture image data including a representation of the object may cause the at least one image sensor to: capture image data including the representation of the object and a representation of the end effector; and the processor-executable instructions or data which cause the at least one processor to determine a third state of the end effector may cause the at least one processor to determine the third state of the end effector based at least partially on the image data. The processor-executable instructions or data which cause the at least one processor to determine the first state of the end effector may cause the at least one processor to determine the first state of the end effector based at least partially on the image data.

The processor-executable instructions or data may further cause at least one proprioceptive sensor of the processor-based system to capture proprioceptive data for the end effector; and the processor-executable instructions or data which cause the at least one processor to determine a third state of the end effector may cause the at least one processor to determine the third state of the end effector relative to the object based at least partially on the proprioceptive data. The processor-executable instructions or data which cause the at least one processor to determine the first state of the end effector may cause the at least one processor to determine the first state of the end effector based at least partially on the proprioceptive data.

The processor-executable instructions or data may further cause the processor-based system to capture, by at least one image sensor of the processor-based system, image data including a representation of the object and a representation of the end effector; and the processor-executable instructions or data which cause the at least one processor to determine a first state of the end effector may cause the at least one processor to determine the first state based on the haptic data and the image data. During transformation of the end effector in accordance with the first transformation trajectory, the processor-executable instructions or data may further cause the processor-based system to: capture, by the at least one haptic sensor, further haptic data in response to the end effector further touching the object; capture, by the at least one image sensor, further image data including a further representation of the object and a further representation of the end effector; identify, by the at least one processor, at least one deviation by the end effector from the first transformation trajectory based on the further haptic data and the further image data; and control, by the at least one processor, the end effector to correct the at least one deviation. During transformation of the end effector in accordance with the first transformation trajectory, the processor-executable instructions or data may further cause the processor-based system to: capture, by the at least one haptic sensor, further haptic data in response to the end effector further touching the object; capture, by the at least one image sensor, further image data including a further representation of the object and a further representation of the end effector; determine, by the at least one processor, an updated second state for the end effector to engage the object based at least partially on the further haptic data and the further image data; determine, by the at least one processor, an updated first transformation trajectory for the end effector to transform the end effector to the updated second state; and control, by the at least one processor, the end effector to transform in accordance with the updated first transformation trajectory.

A robot body may carries the end effector, the at least one haptic sensor, the at least one processor, and the at least one non-transitory processor-readable storage medium.

A robot body may carry the end effector and the at least one haptic sensor; and a remote device remote from the robot body may include the at least one processor and the at least one non-transitory processor-readable storage medium.

A robot body may carry the end effector, the at least one haptic sensor, a first processor of the at least one processor, and a first non-transitory processor-readable storage medium of the at least one non-transitory processor-readable storage medium; a remote device remote from the robot body may include a second processor of the at least one processor, and a second non-transitory processor-readable storage medium of the at least one non-transitory processor-readable storage medium; the robot body and the remote device may communicate via a communication interface; the processor-executable instructions or data may include first processor-executable instructions or data stored at the first non-transitory processor-readable storage medium that when executed cause the processor-based system to: capture the haptic data by the at least one haptic sensor; determine, by the first processor, the first state of the end effector; transmit, by the communication interface, state data indicating the first state from the robot body to the remote device; and control, by the first processor, the end effector to transform in accordance with the first transformation trajectory; the processor-executable instructions or data may include second processor-executable instructions or data stored at the second non-transitory processor-readable storage medium that when executed cause the processor-based system to: determine, by the second processor, the second state; determine, by the second processor, the first transformation trajectory; and transmit, by the communication interface, trajectory data indicating the first transformation trajectory from the remote device to the robot body.

The first state of the end effector may comprise a first position of the end effector; the second state of the end effector may comprise a second position of the end effector different from the first position; the processor-executable instructions or data that cause the at least one processor to determine a first transformation trajectory to transform the end effector from the first state to the second state may cause the at least one processor to: determine a movement trajectory to move the end effector from the first position to the second position; and the processor-executable instructions or data that cause the at least one processor to control the end effector to transform from the first state to the second state may cause the at least one processor to: control the end effector to move the end effector from the first position to the second position in accordance with the movement trajectory.

The first state of the end effector may comprise a first orientation of the end effector; the second state of the end effector may comprise a second orientation of the end effector different from the first orientation; the processor-executable instructions or data that cause the at least one processor to determine a first transformation trajectory to transform the end effector from the first state to the second state may cause the at least one processor to: determine a rotation trajectory to move the end effector from the first orientation to the second orientation; and the processor-executable instructions or data that cause the at least one processor to control the end effector to transform from the first state to the second state may cause the at least one processor to: control the end effector to rotate the end effector from the first orientation to the second orientation in accordance with the rotation trajectory.

The first state of the end effector may comprise a first configuration of the end effector; the second state of the end effector may comprise a second configuration of the end effector different from the first configuration; the processor-executable instructions or data that cause the at least one processor to determine a first transformation trajectory to transform the end effector from the first state to the second state may cause the at least one processor to: determine a first actuation trajectory to actuate the end effector from the first configuration to the second configuration; and the processor-executable instructions or data that cause the at least one processor to control the end effector to transform from the first state to the second state may cause the at least one processor to: control the end effector to actuate the end effector from the first configuration to the second configuration in accordance with the first actuation trajectory.

According to yet another broad aspect, the present disclosure describes a robot control module comprising at least one non-transitory processor-readable storage medium storing processor executable instructions or data that, when executed by at least one processor of a processor-based system, cause the processor-based system to: generate, by at least one haptic sensor coupled to an end effector, haptic data in response to the end effector touching an object; generate, by an artificial intelligence, end effector DOF (degrees of freedom) control signals based at least in part on the haptic data, the end effector DOF control signals being configured to reach a goal in a configuration of the end effector, wherein the processor-executable instructions further cause the artificial intelligence to compensate for variations in end effector DOFs based on the haptic data; provide, by the artificial intelligence, the end effector DOF control signals to an end effector controller; and control, by the end effector controller, at least some of the end effector DOFs based on the end effector DOF control signals.

The processor-executable instructions which cause the processor-based system to compensate for variations in end effector DOFs based on the haptic data may cause the processor-based system to: compensate, by the artificial intelligence, the end effector DOF control signals for variations between expected DOFs of the end effector as expected by the end effector controller based on control instructions the end effector controller executes to control the end effector, and actual DOFs of the end effector determined based on the haptic data.

The processor-executable instructions which cause the processor-based system to compensate for variations in end effector DOFs based on the haptic data may cause the artificial intelligence to: compensate for variations in the end effector DOFs caused by one or more of system errors, parameter drift, or manufacturing tolerances.

The processor-executable instructions which cause the processor-based system to compensate the end effector DOFs for variations between expected DOFs of the end effector as expected by the end effector controller based on control instructions the end effector controller executes to control the end effector, and actual DOFs of the end effector determined based on the haptic data, may cause the processor-based system to: learn, by the artificial intelligence, at least one compensation factor which represents consistent variations between expected DOFs of the end effector as expected by the end effector controller and actual DOFs of the end effector determined based on the haptic data, independent of the object; and apply, by the artificial intelligence, the at least one compensation factor to compensate for variations in the end effector DOFs.

The processor-executable instructions which cause the processor-based system to compensate for variations in end effector DOFs based on the haptic data may cause the artificial intelligence to: compensate the end effector DOF control signals for variations in the end effector DOFs caused by properties of the object. The processor-executable instructions which cause the processor-based system to compensate the end effector DOFs for variations between expected DOFs of the end effector as expected by the end effector controller based on control instructions the end effector controller executes to control the end effector, and actual DOFs of the end effector determined based on the haptic data, may cause the processor-based system to: generate a haptic model by the end effector controller which represents the object, based on the haptic data; and apply, by the artificial intelligence, the haptic model to compensate for variations in the end effector DOFs.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIGS. 1, 2, and 3 are respective illustrative diagrams of exemplary robot systems comprising various features and components described throughout the present systems, methods, and control modules.

FIGS. 4A, 4B, and 4C are respective views of a hand-shaped member having tactile or haptic sensors thereon.

FIG. 5 is a flowchart diagram which illustrates a method of operating a robot system, in accordance with one exemplary illustrated implementation.

FIGS. 6A and 6B illustrate an exemplary scenario where an end effector is controlled to grasp an object.

FIGS. 7A and 7B illustrate an exemplary scenario where an end effector is positioned to push an object.

FIGS. 8A and 8B illustrate an exemplary scenario where an end effector is oriented to be directed to a button.

FIGS. 9A and 9B are side views which illustrate an exemplary scenario where an end effector is transformed to grasp an object.

FIGS. 10A, 10B, and 10C are side views which illustrate an exemplary scenario where an end effector is controlled to grasp an object, compensating for deviations in object properties.

FIGS. 11A, 11B, 11C, and 11D are side views which illustrate an exemplary scenario where an end effector is controlled to grasp an object, compensating for deviations in end effector properties.

FIGS. 12A, 12B, 12C, and 12D are side views which illustrate an exemplary scenario where an end effector is controlled to grasp an object, compensating for deviations in end effector transformation.

FIG. 13 is a flowchart diagram which illustrates a method of operating a robot system, in accordance with another exemplary illustrated implementation.

FIGS. 14A, 14B, 14C, and 14D illustrate an exemplary scenario wherein an end effector is transformed to touch and grasp an object.

FIGS. 15 and 16 are side views which illustrate exemplary scenarios where an end effector is controlled to grasp an object, compensating for deviations based on additional sensor data.

FIG. 17 is a schematic view of a robot system for controlling operation of an end effector, in accordance with one exemplary illustrated implementation.

FIG. 18 is a flowchart diagram illustrating a method of operating a robot system.

### DETAILED DESCRIPTION

The following description sets forth specific details in order to illustrate and provide an understanding of the various implementations and embodiments of the present systems, methods, and control modules. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, methods, and control modules.

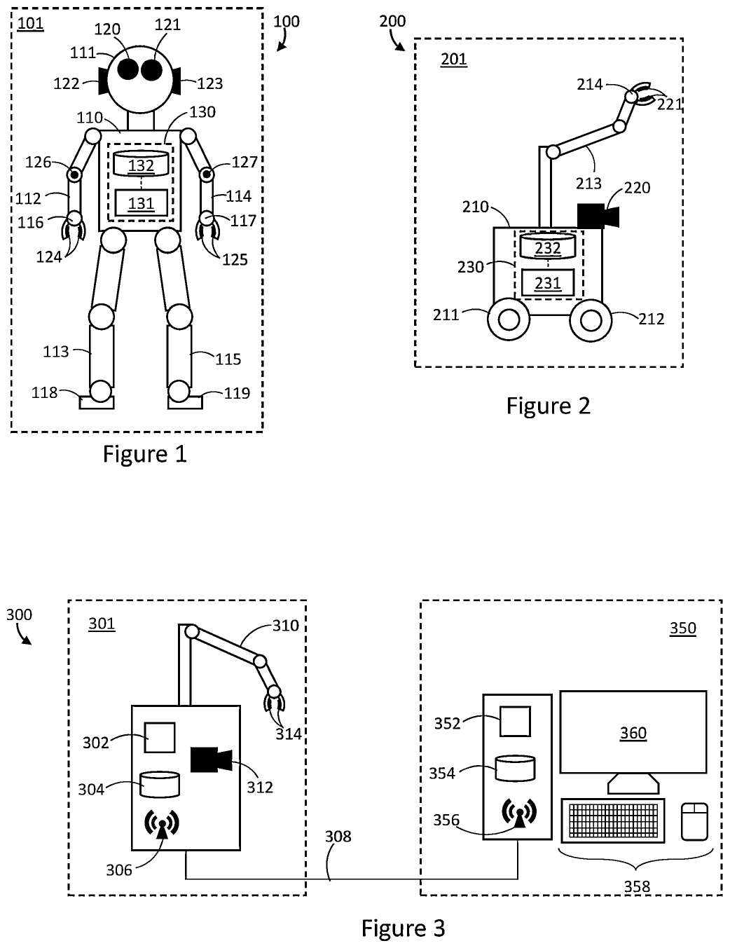

FIG. 1 is a front view of an exemplary robot system 100 in accordance with one implementation. In the illustrated example, robot system 100 includes a robot body 101 that is designed to approximate human anatomy, including a torso 110 coupled to a plurality of components including head 111, right arm 112, right leg 113, left arm 114, left leg 115, right end-effector 116, left end-effector 117, right foot 118, and left foot 119, which approximate anatomical features. More or fewer anatomical features could be included as appropriate for a given application. Further, how closely a robot approximates human anatomy can also be selected as appropriate for a given application.

Each of components 110, 111, 112, 113, 114, 115, 116, 117, 118, and 119 can be actuatable relative to other components. Any of these components which is actuatable relative to other components can be called an actuatable member. Actuators, motors, or other movement devices can couple together actuatable components. Driving said actuators, motors, or other movement driving mechanism causes actuation of the actuatable components. For example, rigid limbs in a humanoid robot can be coupled by motorized joints, where actuation of the rigid limbs is achieved by driving movement in the motorized joints.

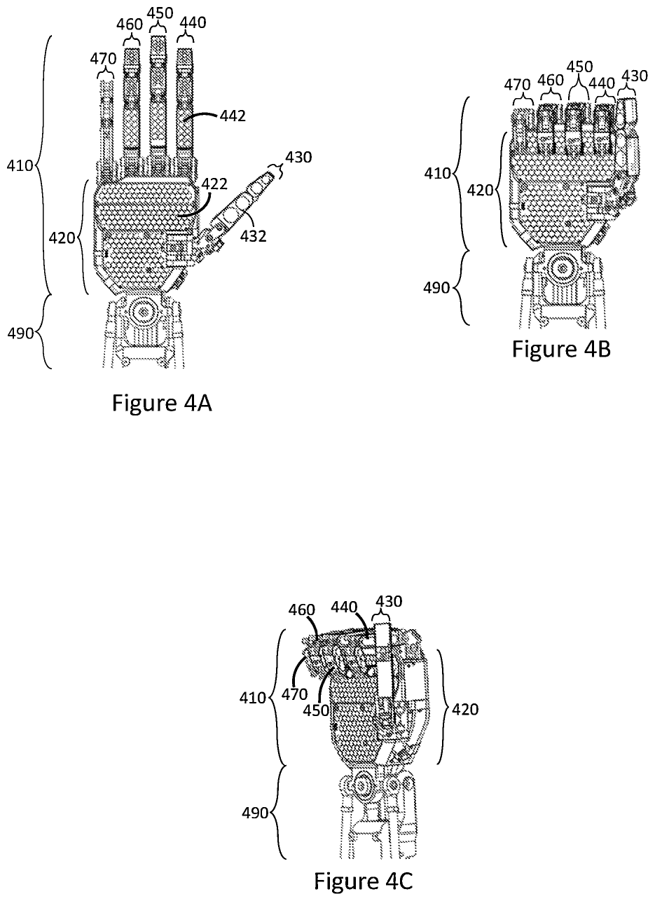

End effectors 116 and 117 are shown in FIG. 1 as grippers, but any end effector could be used as appropriate for a given application. FIGS. 4A, 4B, and 4C discussed later illustrate an exemplary case where the end effectors can be hand-shaped members.

Right leg 113 and right foot 118 can together be considered as a support member and/or a locomotion member, in that the leg 113 and foot 118 together can support robot body 101 in place, or can move in order to move robot body 101 in an environment (i.e. cause robot body 101 to engage in locomotion). Left leg 115 and left foot 119 can similarly be considered as a support member and/or a locomotion member. Legs 113 and 115, and feet 118 and 119 are exemplary support and/or locomotion members, and could be substituted with any support members or locomotion members as appropriate for a given application. For example, FIG. 2 discussed later illustrates wheels as exemplary locomotion members instead of legs and feet.

Robot system 100 in FIG. 1 includes a robot body 101 that closely approximates human anatomy, such that input to or control of robot system 100 can be provided by an operator performing an action, to be replicated by the robot body 101 (e.g. via a tele-operation suit or equipment). In some implementations, it is possible to even more closely approximate human anatomy, such as by inclusion of actuatable components in a face on the head 111 of robot body 101, or with more detailed design of hands or feet of robot body 101, as non-limiting examples. However, in other implementations a complete approximation of the human anatomy is not required, and a robot body may only approximate a portion of human anatomy. As non-limiting examples, only an arm of human anatomy, only a head or face of human anatomy; or only a leg of human anatomy could be approximated.

Robot system 100 is also shown as including sensors 120, 121, 122, 123, 124, 125, 126, and 127 which collect context data representing an environment of robot body 101. In the example, sensors 120 and 121 are image sensors (e.g. cameras) that capture visual data representing an environment of robot body 101. Although two image sensors 120 and 121 are illustrated, more or fewer image sensors could be included. Also in the example, sensors 122 and 123 are audio sensors (e.g. microphones) that capture audio data representing an environment of robot body 101. Although two audio sensors 122 and 123 are illustrated, more or fewer audio sensors could be included. In the example, haptic (tactile) sensors 124 are included on end effector 116, and haptic (tactile) sensors 125 are included on end effector 117. Haptic sensors 124 and 125 can capture haptic data (or tactile data) when objects in an environment are touched or grasped by end effectors 116 or 117. Haptic or tactile sensors could also be included on other areas or surfaces of robot body 101. Also in the example, proprioceptive sensor 126 is included in arm 112, and proprioceptive sensor 127 is included in arm 114. Proprioceptive sensors can capture proprioceptive data, which can include the position(s) of one or more actuatable member(s) and/or force-related aspects of touch, such as force-feedback, resilience, or weight of an element, as could be measured by a torque or force sensor (acting as a proprioceptive sensor) of an actuatable member which causes touching of the element. “Proprioceptive” aspects of touch which can also be measured by a proprioceptive sensor can also include kinesthesia, motion, rotation, or inertial effects experienced when a member of a robot touches an element, as can be measured by sensors such as an Inertial measurement unit (IMU), and accelerometer, a gyroscope, or any other appropriate sensor (acting as a proprioceptive sensor).

Four types of sensors are illustrated in the example of FIG. 1, though more or fewer sensor types could be included. For example, audio sensors may not be included. As another example, other sensor types, such as accelerometers, inertial sensors, gyroscopes, temperature sensors, humidity sensors, pressure sensor, radiation sensors, or any other appropriate types of sensors could be included. Further, although sensors 120 and 121 are shown as approximating human eyes, and sensors 122 and 123 are shown as approximating human ears, sensors 120, 121, 122, and 123 could be positioned in any appropriate locations and have any appropriate shape.

Throughout this disclosure, reference is made to “haptic” sensors, “haptic” feedback, and “haptic” data. Herein, “haptic” is intended to encompass all forms of touch, physical contact, or feedback. This can include (and be limited to, if appropriate) “tactile” concepts, such as texture or feel as can be measured by a tactile sensor. Unless context dictates otherwise, “haptic” can also encompass “proprioceptive” aspects of touch.

Robot system 100 is also illustrated as including at least one processor 131, communicatively coupled to at least one non-transitory processor-readable storage medium 132. The at least one processor 131 can control actuation of components 110, 111, 112, 113, 114, 115, 116, 117, 118, and 119; can receive and process data from sensors 120, 121, 122, 123, 124, 125, 126, and 127; can determine context of the robot body 101, and can determine transformation trajectories, among other possibilities. The at least one non-transitory processor-readable storage medium 132 can have processor-executable instructions or data stored thereon, which when executed by the at least one processor 131 can cause robot system 100 to perform any of the methods discussed herein. Further, the at least one non-transitory processor-readable storage medium 132 can store sensor data, classifiers, or any other data as appropriate for a given application. The at least one processor 131 and the at least one processor-readable storage medium 132 together can be considered as components of a “robot controller” 130, in that they control operation of robot system 100 in some capacity. While the at least one processor 131 and the at least one processor-readable storage medium 132 can perform all of the respective functions described in this paragraph, this is not necessarily the case, and the “robot controller” 130 can be or further include components that are remote from robot body 101. In particular, certain functions can be performed by at least one processor or at least one non-transitory processor-readable storage medium remote from robot body 101, as discussed later with reference to FIG. 3.

In some implementations, it is possible for a robot body to not approximate human anatomy. FIG. 2 is an elevated side view of a robot system 200 including a robot body 201 which does not approximate human anatomy. Robot body 201 includes a base 210, having actuatable components 211, 212, 213, and 214 coupled thereto. In the example, actuatable components 211 and 212 are wheels (locomotion members) which support robot body 201, and provide movement or locomotion capabilities to the robot body 201. Actuatable components 213 and 214 are a support arm and an end effector, respectively. The description for end effectors 116 and 117 in FIG. 1 is applicable to end effector 214 in FIG. 2. End effector 214 can also take other forms, such as a hand-shaped member as discussed later with reference to FIGS. 4A, 4B, and 4C. In other examples, other actuatable components could be included.

Robot system 200 also includes sensor 220, which is illustrated as an image sensor. Robot system 200 also includes a haptic sensor 221 positioned on end effector 214. The description pertaining to sensors 120, 121, 122, 123, 124, 125, 126, and 127 in FIG. 1 is also applicable to sensors 220 and 221 in FIG. 2 (and is applicable to inclusion of sensors in robot bodies in general). End effector 214 can be used to touch, grasp, or manipulate objects in an environment. Further, any number of end effectors could be included in robot system 200 as appropriate for a given application or implementation.

Robot system 200 is also illustrated as including a local or on-board robot controller 230 comprising at least one processor 231 communicatively coupled to at least one non-transitory processor-readable storage medium 232. The at least one processor 231 can control actuation of components 210, 211, 212, 213, and 214; can receive and process data from sensors 220 and 221; and can determine context of the robot body 201 and can determine transformation trajectories, among other possibilities. The at least one non-transitory processor-readable storage medium 232 can store processor-executable instructions or data that, when executed by the at least one processor 231, can cause robot body 201 to perform any of the methods discussed herein. Further, the at least one processor-readable storage medium 232 can store sensor data, classifiers, or any other data as appropriate for a given application.

FIG. 3 is a schematic diagram illustrating components of a robot system 300 comprising a robot body 301 and a physically separate remote device 350 in accordance with the present robots and methods.

Robot body 301 is shown as including at least one local or on-board processor 302, a non-transitory processor-readable storage medium 304 communicatively coupled to the at least one processor 302, a wireless communication interface 306, a wired communication interface 308, at least one actuatable component 310, at least one sensor 312, and at least one haptic sensor 314. However, certain components could be omitted or substituted, or elements could be added, as appropriate for a given application. As an example, in many implementations only one communication interface is needed, so robot body 301 may include only one of wireless communication interface 306 or wired communication interface 308. Further, any appropriate structure of at least one actuatable portion could be implemented as the actuatable component 310 (such as those shown in FIGS. 1 and 2, for example). For example, robot body 101 as described with reference to FIG. 1, or robot body 201 described with reference to FIG. 2, could be used in place of robot body 301, and communication interface 306 or communication interface 308 could be implemented therein to enable communication with remote device 350. Further still, the at least one sensor 312 and the at least one haptic sensor 314 can include any appropriate quantity or type of sensor, as discussed with reference to FIGS. 1 and 2.

Remote device 350 is shown as including at least one processor 352, at least one non-transitory processor-readable medium 354, a wireless communication interface 356, a wired communication interface 308, at least one input device 358, and an output device 360. However, certain components could be omitted or substituted, or elements could be added, as appropriate for a given application. As an example, in many implementations only one communication interface is needed, so remote device 350 may include only one of wireless communication interface 356 or wired communication interface 308. As another example, input device 358 can receive input from an operator of remote device 350, and output device 360 can provide information to the operator, but these components are not essential in all implementations. For example, remote device 350 can be a server which communicates with robot body 301, but does not require operator interaction to function. Additionally, output device 360 is illustrated as a display, but other output devices are possible, such as speakers, as a non-limiting example. Similarly, the at least one input device 358 is illustrated as a keyboard and mouse, but other input devices are possible.

In some implementations, the at least one processor 302 and the at least one processor-readable storage medium 304 together can be considered as a “robot controller”, which controls operation of robot body 301. In other implementations, the at least one processor 352 and the at least one processor-readable storage medium 354 together can be considered as a “robot controller” which controls operation of robot body 301 remotely. In yet other implementations, that at least one processor 302, the at least one processor 352, the at least one non-transitory processor-readable storage medium 304, and the at least one processor-readable storage medium 354 together can be considered as a “robot controller” (distributed across multiple devices) which controls operation of robot body 301. “Controls operation of robot body 301” refers to the robot controller's ability to provide instructions or data for operation of the robot body 301 to the robot body 301. In some implementations, such instructions could be explicit instructions which control specific actions of the robot body 301. In other implementations, such instructions or data could include broader instructions or data which guide the robot body 301 generally, where specific actions of the robot body 301 are controlled by a control unit of the robot body 301 (e.g. the at least one processor 302), which converts the broad instructions or data to specific action instructions. In some implementations, a single remote device 350 may communicatively link to and at least partially control multiple (i.e., more than one) robot bodies. That is, a single remote device 350 may serve as (at least a portion of) the respective robot controller for multiple physically separate robot bodies 301.

FIGS. 4A, 4B, and 4C illustrate an exemplary end effector 410 coupled to a member 490 of a robot body. Member 490 could be, for example, an arm of robot body 101, 201, or 301 in FIG. 1, 2, or 3. As a specific example, member 490 could correspond to arm 112 or arm 114 in robot body 101 in FIG. 1. In the illustrated example, end effector 410 is hand-shaped, to grasp, grip, handle, manipulate, touch, or release objects similar to how a human hand would. In the illustrated example, end effector 410 includes finger-shaped members 430, 440, 450, 460, and 470. Although five finger-shaped members are illustrated, any number of finger-shaped members could be included as appropriate for a given application. Each of finger-shaped members 430, 440, 450, 460, and 470 are coupled to a palm-shaped member 420. Palm-shaped member 420 serves as a common member to which the finger-shaped members are coupled. In the example, each of finger-shaped members 430, 440, 450, 460, and 470 are actuatable relative to the palm-shaped member 420 at a respective joint. The finger-shaped members can also include joints at which sub-members of a given finger-shaped member are actuatable. A finger-shaped member can include any number of sub-members and joints, as appropriate for a given application.

End effector 410 in FIGS. 4A, 4B, and 4C can be referred to as a “hand-shaped member”. Similar language is used throughout this disclosure, and is sometimes abbreviated to simply “hand” for convenience.

In some implementations, the end effectors and/or hands described herein, including but not limited to hand 410, may incorporate any or all of the teachings described in U.S. patent application Ser. No. 17/491,577, U.S. patent application Ser. No. 17/749,536, U.S. Provisional Patent Application Ser. No. 63/323,897, and/or U.S. Provisional Patent Application Ser. No. 63/342,414, each of which is incorporated herein by reference in its entirety.

Although joints are not explicitly labelled in FIGS. 4A, 4B, and 4C to avoid clutter, the location of such joints can be understood based on the different configurations of end-effector 410 shown in FIGS. 4A, 4B, and 4C. FIG. 4A is a front-view which illustrates end effector 410 in an open configuration, with finger-shaped members 430, 440, 450, 460, and 470 extended from palm-shaped member 420 (for example to receive or touch an object). FIG. 4B is a front view which illustrates end effector 410 in a closed configuration, with finger-shaped members 430, 440, 450, 460, and 470 closed into palm-shaped member 420 (for example to grasp or grip an object). FIG. 4C is an isometric view which illustrates end effector 410 in the closed configuration as in FIG. 4B. The closed configuration of FIGS. 4B and 4C can also be called a contracted configuration, in that finger-shaped members 430, 440, 450, 460, and 470 are “contracted” inward relative to each other. The closed configuration can also be referred to as a grasp configuration, used for grasping an object.

Additionally, FIGS. 4A, 4B, and 4C illustrate a plurality of tactile sensors 422, 432, and 442 on respective palm-shaped member 420 and finger-shaped members 430 and 440. Similar tactile sensors are optionally included on finger-shaped members 450 and 460 which are not labelled to avoid clutter. Finger-shaped member 470 is illustrated without tactile sensors thereon, which is indicative that in some implementations a hand-shaped member may be only partially covered by tactile sensors (although full cover by tactile sensors is possible in other implementations). Such tactile sensors can collect tactile data. Further, these “tactile” sensors can also be referred to as “haptic” sensors, in that they collect data relating to touch, which is included in haptic data as discussed earlier.

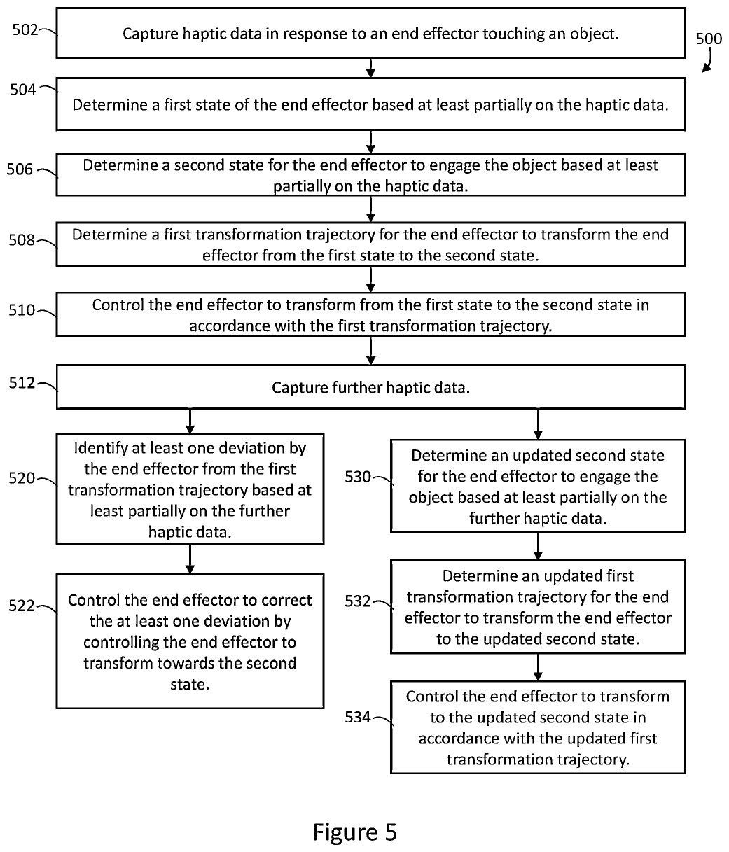

FIG. 5 is a flowchart diagram showing an exemplary method 500 of operating a robot system. Method 500 pertains to operation of a robot system, which includes at least one processor, at least one haptic sensor, and at least one end effector. The system can also include at least one non-transitory processor-readable storage medium storing data and/or processor-executable instructions that, when executed by the at least one processor, cause the system to perform the method. In the exemplary implementations discussed hereafter, the system comprises a robot, which includes a robot body such as those illustrated in FIGS. 1, 2, and 3, and optionally can include a remote device such as that illustrated in FIG. 3. Certain acts of a method of operation of a robot system may be performed by at least one processor or processing unit (hereafter “processor”) positioned at the robot body, and communicatively coupled to a non-transitory processor-readable storage medium positioned at the robot body. The robot body may communicate, via communications and networking hardware communicatively coupled to the robot body's at least one processor, with remote systems and/or remote non-transitory processor-readable storage media, as discussed above with reference to FIG. 3. Thus, unless the specific context requires otherwise, references to a robot system's processor, non-transitory processor-readable storage medium, as well as data and/or processor-executable instructions stored in a non-transitory processor-readable storage medium, are not intended to be limiting as to the physical location of the processor or non-transitory processor-readable storage medium in relation to the robot body and the rest of the robot hardware. In other words, a robot system's processor or non-transitory processor-readable storage medium may include processors or non-transitory processor-readable storage media located on-board the robot body and/or non-transitory processor-readable storage media located remotely from the robot body, unless the specific context requires otherwise. Further, a method of operation of a system such as method 500 (or any of the other methods discussed herein) can be implemented as a robot control module or computer program product. Such a robot control module or computer program product is data-based, and comprises processor-executable instructions or data that, when the robot control module or computer program product is stored on a non-transitory processor-readable storage medium of the system, and the robot control module or computer program product is executed by at least one processor of the system, the robot control module or computer program product (or the processor-executable instructions or data thereof) cause the system to perform acts of the method.

Returning to FIG. 5, method 500 as illustrated includes acts 502, 504, 506, 508, 510, 512, 520, 522, 530, 532, and 534, though those of skill in the art will appreciate that in alternative implementations certain acts may be omitted and/or additional acts may be added. For example, acts 520, 522, 530, 532, and 534 are optional acts that can be omitted as appropriate for a given application. Those of skill in the art will also appreciate that the illustrated order of the acts is shown for exemplary purposes only and may change in alternative implementations.

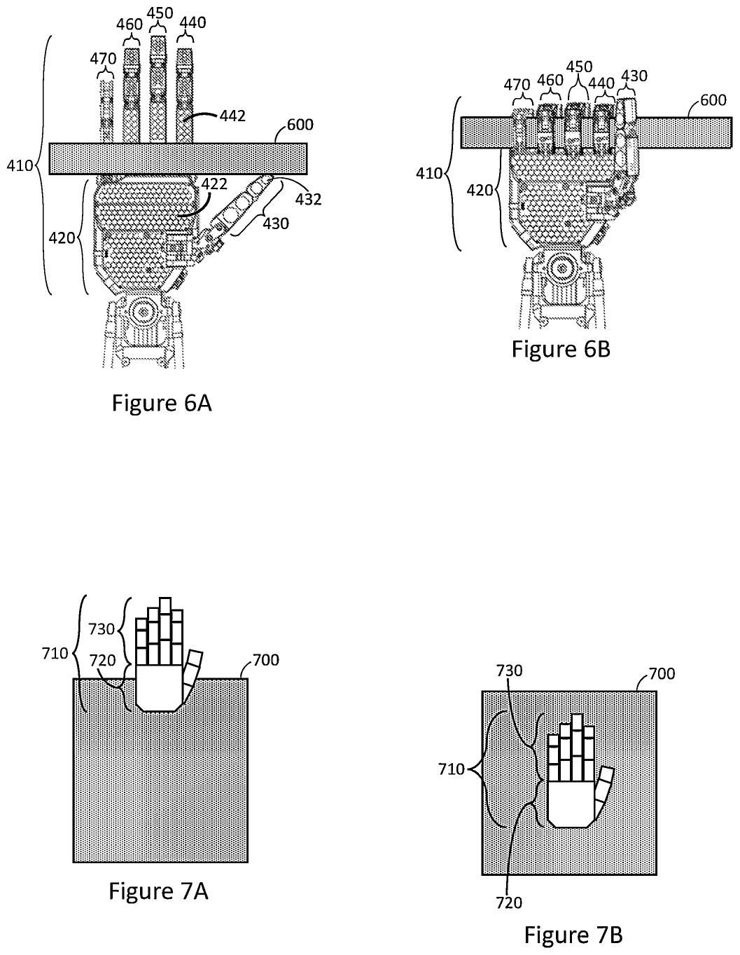

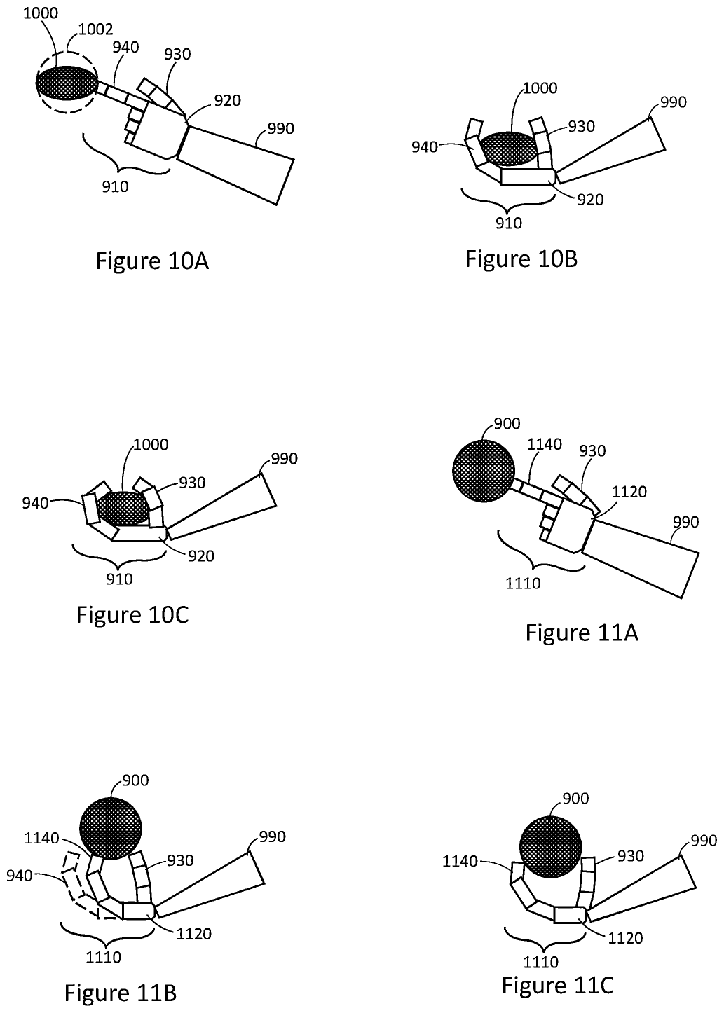

At 502, the at least one haptic sensor of the robot system captures haptic data in response to the end effector of the robot system touching an object. At 504, a first state of the end effector is determined (e.g., by the at least one processor of the robot system) based at least partially on the haptic data. At 506, a second state for the end effector to engage the object is determined (e.g., by the at least one processor of the robot system) based at least partially on the haptic data. In order to determine the first state and/or the second state, the object may first be identified, or attributes of the object may be identified. The extent of identification of the object is dependent on application, as is described later. At 508, a first transformation trajectory for the end effector to transform the end effector from the first state to the second state is determined (e.g., by the at least one processor of the robot system). At 510, the at least one processor of the robot system controls the end effector to transform from the first state to the second state in accordance with the first transformation trajectory. Detailed examples of acts 502, 504, 506, 508, and 510 are discussed below with reference to FIGS. 6A, 6B, 7A, 7B, 8A, 8B, 9A, and 9B. Optional acts 520, 522, 530, 532, and 534 are discussed later with reference to FIGS. 10A, 10B, 10C, 11A, 11B, 11C, 11D, 12A, 12B, 12C, and 12D.

Throughout this disclosure, reference is made to “states” of end effectors. Generally, a “state” of an end effector refers to a position, orientation, configuration, and/or pose of the end effector. Stated different, a “state” of an end effector refers to where an end effector is located, in what way an end effector is rotated, and/or how components of the end effector are positioned, rotated, arranged, and/or configured relative to each other. Each of the aspects is not necessarily required to define a particular “state” (for example, a basic end effector such as a pointer may have only one configuration), but any and all of these aspects can together represent a state of an end effector, as appropriate for a given application or scenario.

FIGS. 6A and 6B illustrate end effector (hand) 410 and object 600. For exemplary purposes, end effector 410 in FIGS. 6A and 6B is similar to end effector 410 discussed with reference to FIGS. 4A, 4B, and 4C earlier, and description of FIGS. 4A, 4B, and 4C applies to FIGS. 6A and 6B unless context dictates otherwise. In FIG. 6A, end effector 410 touches object 600, and haptic data is captured as in act 502 of method 500 (e.g., by any of haptic/tactile sensors 422, 432, or 442, depending where object 600 is touched by end effector 410). At least partially based on the captured haptic data, a first state of the end effector 410 is determined as in act 504 of method 500. In the example of FIG. 6A, the first state of the end effector 410 can comprise a determination of where the end effector 410 is positioned and touching the object 600. For example, object 600 contacts haptic sensors of end effector 410 in a linear manner (because object 600 has a linear shape). Based on this, the position, orientation, and or configuration of end effector 410 relative to object 600 can be determined. In some implementations, determining the first state of the end effector at act 504 in method 500 can be based on more than just the captured haptic data (e.g., additional image data, as is discussed later).

Also at least partially based on the captured haptic data, a second state for the end effector 410 to engage the object is determined as in act 506 of method 500. FIG. 6B illustrates this second state, as a state where end effector 410 grasps object 600. In particular, finger-shaped members 430, 440, 450, 460, and 470 are shown as wrapping around object 600 (also referred to as a closed configuration). Other forms of engagement are also possible, such as pressing, pushing, pulling, poking, gripping, pinching, guiding, or otherwise touching object 600. In a sense, the second state can also be referred to as a “goal state”, in that the second state is determined as a state which the end effector is to be transformed to, from the first state. Determination of the second state can be informed by an overall objective or role of the robot system. In an exemplary scenario, the robot system has an objective to pick up object 600 and move object 600 to another location. Based on this, the second state is determined as a state where end effector 410 will securely grasp object 600 for movement thereof.

After determining the first and second states of the end effector 410 in accordance with acts 504 and 506 of method 500, a first transformation trajectory is determined for end effector 410 to transform from the first state to the second state, as in act 508 of method 500. In the example of FIG. 6A, object 600 is already positioned relative to end effector 410 in the first state such that the finger-shaped members 430, 440, 450, 460, and 470 need only curl to close around object 600 as shown in FIG. 6B. Thus, a first transformation trajectory is determined whereby finger-shaped members 430, 440, 450, 460, and 470 are curled to appropriate respective positions (e.g., end effector 410 is entered into a “curl” configuration or “fist” configuration) to wrap around object 600.

After determining the first transformation trajectory as in act 508, the at least one processor of the robot system controls end effector 410 to transform from the first state in FIG. 6A to the second state in FIG. 6B in accordance with the first transformation trajectory, as in act 510 of method 500. That is, the at least one processor sends control signals or instructions to any appropriate motors, rotors, or other actuation hardware to cause transformation of end effector 410 in accordance with the first transformation trajectory.

The example of FIGS. 6A and 6B is an example where the first state comprises a first configuration of the end effector (hand) 410, and the second state comprises a second configuration of the end effector 410 different from the first configuration. In this context, a “configuration” refers to the relative positioning and orientation of components of the end effector relative to each other. In the example of FIGS. 6A and 6B, “configurations” of end effector 410 refer to relative positions and orientations of finger-shaped members 430, 440, 450, 460, and 470, and palm-shaped member 420. Determining a first transformation trajectory to transform the end effector from the first state to the second state, where the first state and the second state comprise different configurations of the end effector, comprises determining an actuation trajectory to actuate the end effector from the first configuration to the second configuration. That is, in the example of FIGS. 6A and 6B, the first transformation trajectory comprises a trajectory which causes finger-shaped members 430, 440, 450, 460, and 470 to actuate to curl around object 600. In this example, at 510, controlling the end effector to transform from the first state to the second state comprises controlling the end effector to actuate from the first configuration to the second configuration; that is, controlling the end effector 410 to actuate finger-shaped members 430, 440, 450, 460, and 470 to actuate to curl around object 600.

While FIGS. 6A and 6B illustrate transformation of a configuration of an end effector, a transformation trajectory can also comprise transformation of position, orientation, and/or pose of the end effector, as discussed later with reference to FIGS. 9A, and 9B. Further, while FIGS. 6A and 6B illustrate a hand-shaped member, the discussion thereof applies to any appropriate form of end effector.

FIGS. 7A and 7B illustrate end effector 710 and object 700. End effector 710 is an exemplary end effector in the context of method 500, and is similar to end effector 410 described with reference to FIGS. 4A, 4B, and 4C. Unless context dictates otherwise, description of FIGS. 4A, 4B, and 4C applies to end effector 710 in FIGS. 7A and 7B. End effector 710 is shown as including a palm-shaped portion 720 and finger-shaped members 730. To reduce clutter and streamline discussion, many features of end effector 710 (such as individual finger-shaped members and sensors of end effector 710) are not explicitly labelled in FIGS. 7A and 7B.

In FIG. 7A, end effector 710 touches object 700, and haptic data is captured as in act 502 of method 500 (by any haptic/tactile sensors on end effector 710, depending where object 700 touches on end effector 710). At least partially based on the captured haptic data, a first state of the end effector 710 is determined as in act 504 of method 500. In the example of FIG. 7A, the first state of the end effector 710 can comprise a determination (or at least, an approximation) of where the end effector 710 is positioned and touching the object 700. For example, object 700 contacts haptic sensors on palm-shaped portion 720 of end effector 710. Based on this, the position, orientation, and or configuration of end effector 710 relative to object 700 can be determined (in the illustrated example, that end effector 710 contacts object 700 at a top edge thereof). In some implementations, act 504 in method 500 can be based on more than just the captured haptic data (e.g., additional image data, as is discussed later).

Also at least partially based on the captured haptic data, a second state for the end effector 710 to engage the object 700 is determined as in act 506 of method 500. FIG. 7B illustrates this second state, as a state where end effector 710 is positioned at a different location relative to object 700. In particular, end effector 710 is shown as being positioned near a center of a face of object 700. In the context of FIG. 7B, this form of engagement is for the purpose of pushing object 700. However, other forms of engagement are also possible, such as grasping, guiding, or otherwise touching object 700. Similar to as discussed with reference to FIGS. 6A and 6B, the second state can also be referred to as a “goal state”, in that the second state is determined as a state which the end effector is to be transformed to, from the first state. Determination of the second state can be informed by an overall objective or role of the robot system. In an exemplary scenario, the robot system has an objective to push object 700 to move object 700 to another location. Based on this, the second state is determined as a state where end effector 710 will push object 700 effectively. In the exemplary first state shown in FIG. 7A, pushing object 700 at the top edge thereof may result in object 700 tipping over, in contrast to the desired objective of moving object 700. In the second state shown in FIG. 7B, pushing object 700 at a center thereof should result in object 700 moving in a desired way.

After determining the first and second states of the end effector 710 in accordance with acts 504 and 506 of method 500, a first transformation trajectory is determined for end effector 710 to transform from the first state to the second state, as in act 508 of method 500. In the example of FIGS. 7A and 7B, end effector 710 needs to move from the top region of object 700 to a center region of object 700. Thus, a first transformation trajectory is determined whereby end effector 710 is moved to be positioned as shown in FIG. 7B.

After determining the first transformation trajectory as in act 508, the at least one processor of the robot system controls end effector 710 to transform from the first state in FIG. 7A to the second state in FIG. 7B in accordance with the first transformation trajectory, as in act 510 of method 500. That is, the at least one processor sends control signals or instructions to any appropriate motors, rotors, or other actuation hardware to cause transformation of end effector 710 in accordance with the first transformation trajectory. In the illustrated example, movement of end effector 710 can be caused by actuation of an actuatable member attached thereto. For example, end effector 710 can be connected to an arm-shaped member, and movement of end effector 710 can be caused by actuation of the arm-shaped member. Determining and controlling movement of actuatable members is described in more detail with reference to FIGS. 9A and 9B.

The example of FIGS. 7A and 7B is an example where the first state comprises a first position of the end effector (hand) 710, and the second state comprises a second position of the end effector different from the first position. Determining a transformation trajectory to transform the end effector from the first state to the second state, where the first state and the second state comprise different positions of the end effector, comprises determining a movement trajectory to move the end effector from the first position to the second position. That is, in the example of FIGS. 7A and 7B, the first transformation trajectory comprises a trajectory which causes end effector 710 as a whole to move to a new position (e.g., via movement of one or more actuatable member(s) to which end effector 710 is physically coupled). In this example, at 510 in method 500, controlling the end effector to transform from the first state to the second state comprises controlling the end effector to move from the first position to the second position.

While FIGS. 7A and 7B illustrate transformation of a position of an end effector, a transformation trajectory can also comprise transformation of configuration, orientation and/or pose of the end effector, as discussed later with reference to FIGS. 9A and 9B. Further, while FIGS. 7A and 7B illustrate a hand-shaped member as the end effector, the discussion thereof applies to any appropriate form of end effector.

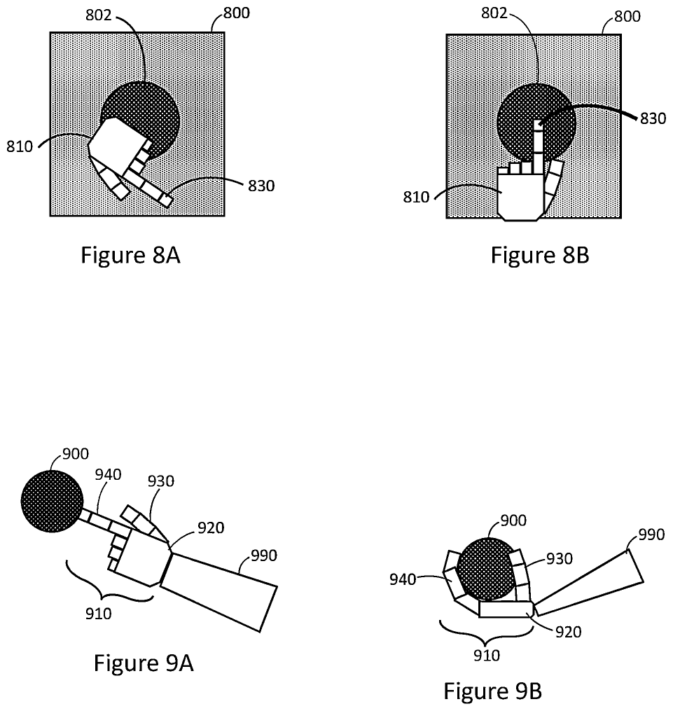

FIGS. 8A and 8B illustrate end effector 810 and object 800. End effector 810 is an exemplary end effector in the context of method 500, and is similar to end effector 410 described with reference to FIGS. 4A, 4B, and 4C. Unless context dictates otherwise, description of FIGS. 4A, 4B, and 4C applies to end effector 810 in FIGS. 8A and 8B. End effector 810 is shown as including at least one finger-shaped member 830. To reduce clutter and streamline discussion, many features of end effector 810 (such as other finger-shaped members, components, and sensors of end effector 810) are not explicitly labelled in FIGS. 8A and 8B.

In FIG. 8A, end effector 810 touches object 800, and haptic data is captured as in act 502 of method 500 (by any haptic/tactile sensors on end effector 810, depending where object 800 touches end effector 810). At least partially based on the captured haptic data, a first state of the end effector 810 is determined as in act 504 of method 500. In the example of FIG. 8A, the first state of the end effector 810 can comprise a determination of how end effector 810 is touching the object 800. For example, object 800 contacts haptic sensors on finger-shaped member 830 of end effector 810. Based on this, the position, orientation, and or configuration of end effector 810 relative to object 800 can be determined. In the illustrated example, that end effector 810 contacts object 800 away from a button 802 thereof. In some implementations, act 504 in method 500 can be based on more than just the captured haptic data (e.g., additional image data, as is discussed later).

Also at least partially based on the captured haptic data, a second state for the end effector 810 to engage the object 800 is determined as in act 506 of method 500. FIG. 8B illustrates this second state, as a state where end effector 810 is positioned at a different orientation relative to object 800. In particular, end effector 810 is shown in FIG. 8B as being oriented such that finger-shaped member 830 is positioned at button 802 of object 800. In the context of FIG. 8B, this form of engagement is for the purpose of pressing button 802 of object 800. However, other forms of engagement are also possible, such as grasping, pushing, pulling, guiding, or otherwise touching object 800. Similar to as discussed with reference to FIGS. 6A, 6B, 7A, and 7B, the second state can also be referred to as a “goal state”, in that the second state is determined as a state which the end effector is to be transformed to, from the first state. Determination of the second state can be informed by an overall objective or role of the robot system. In an exemplary scenario, the robot system has an objective to press button 802 (e.g. in response to an environmental stimulus such as an emergency situation). Based on this, the second state is determined as a state where end effector 810 is oriented to press button 802 as needed. In the exemplary first state shown in FIG. 8A, end effector 810 is oriented such that attempting to push button 802 by finger shaped member 830 would not be optimally efficient; that is, end effector 810 is oriented such that finger-shaped member 830 is not positioned over button 802. In the second state shown in FIG. 8B, end effector 810 is oriented such that finger-shaped member 830 is positioned over button 802, ready to quickly push button 802 as needed.

After determining the first and second states of the end effector 810 in accordance with acts 504 and 506 of method 500, a first transformation trajectory is determined for end effector 810 to transform from the first state to the second state, as in act 508 of method 500. In the example of FIGS. 8A and 8B, end effector 810 needs to rotate from the orientation shown in FIG. 8A to the orientation shown in FIG. 8B. Thus, a first transformation trajectory is determined whereby end effector 810 is rotated to the orientation shown in FIG. 8B.

After determining the first transformation trajectory as in act 508, the at least one processor of the robot system controls end effector 810 to transform from the first state in FIG. 8A to the second state in FIG. 8B in accordance with the first transformation trajectory, as in act 510 of method 500. That is, the at least one processor sends control signals or instructions to any appropriate motors, rotors, or other actuation hardware to cause transformation of end effector 810 in accordance with the first transformation trajectory. In the illustrated example, rotation of end effector 810 can be caused by actuation of an actuatable member attached thereto. For example, end effector 810 can be connected to an arm-shaped member, and rotation of end effector 810 can be caused by actuation of the arm-shaped member. Determining and controlling movement of actuatable members is described in more detail with reference to FIGS. 9A and 9B.

The example of FIGS. 8A and 8B is an example where the first state comprises a first orientation of the end effector (hand) 810, and the second state comprises a second orientation of the end effector different from the first orientation. Determining a transformation trajectory to transform the end effector from the first state to the second state, where the first state and the second state comprise different orientations of the end effector, comprises determining a rotation trajectory to rotate the end effector from the first orientation to the second orientation (e.g., by accordingly rotating or otherwise reorienting one or more actuatable members) to which the end effector is physically coupled). That is, in the example of FIGS. 8A and 8B, the first transformation trajectory comprises a trajectory which causes end effector 810 as a whole to rotate to a new orientation. In this example, at 510 in method 500, controlling the end effector to transform from the first state to the second state comprises controlling the end effector to rotate from the first orientation to the second orientation.

While FIGS. 8A and 8B illustrate transformation of an orientation of an end effector, a transformation trajectory can also comprise transformation of configuration, position, and/or pose of the end effector, as discussed later with reference to FIGS. 9A and 9B. Further, while FIGS. 8A and 8B illustrate a hand-shaped member as the end effector, the discussion thereof applies to any appropriate form of end effector.

FIGS. 9A and 9B illustrate end effector 910 and object 900. End effector 910 is an exemplary end effector in the context of method 500, and is similar to end effector 410 described with reference to FIGS. 4A, 4B, and 4C. Unless context dictates otherwise, description of FIGS. 4A, 4B, and 4C applies to end effector 910 in FIGS. 9A and 9B. End effector 910 is shown as including a palm-shaped portion 920 and finger-shaped members 930 and 940. To reduce clutter and streamline discussion, many features of end effector 910 (such as other finger-shaped members and sensors of end effector 910) are not explicitly labelled in FIGS. 9A and 9B.

In FIG. 9A, end effector 910 touches object 900, and haptic data is captured as in act 502 of method 500 (by any haptic/tactile sensors on hand 910, depending where object 900 touches end effector 910). At least partially based on the captured haptic data, a first state of the end effector 910 is determined as in act 504 of method 500. In the example of FIG. 9A, the first state of the end effector 910 can comprise a determination of how the end effector 910 is positioned, oriented, configured, and/or posed in relation to (and how it is touching) the object 900. For example, object 900 contacts haptic sensors on finger-shaped member 940 of end effector 910. Based on this, the position, orientation, and or configuration of end effector 910 relative to object 900 can be determined. In some implementations, act 504 in method 500 can be based on more than just the captured haptic data (e.g., additional image data, as is discussed later).

Also at least partially based on the captured haptic data, a second state for the end effector 910 to engage the object 900 is determined as in act 506 of method 500. FIG. 9B illustrates this second state, as a state where end effector 910 is positioned at a different position, in a different orientation, in a different configuration, and/or differently posed, relative to object 900 than the first state shown in FIG. 9A. In particular, end effector 910 is shown as being positioned under object 900, and grasping object 900 from below. In the context of FIG. 9B, this form of engagement is for the purpose of holding object 900. However, other forms of engagement are also possible, such as grasping, guiding, pushing, pulling, or otherwise touching object 900. Similar to as discussed with reference to FIGS. 6A and 6B, the second state can also be referred to as a “goal state”, in that the second state is determined as a state which the end effector is to be transformed to, from the first state. Determination of the second state can be informed by an overall objective or role of the robot system. In an exemplary scenario, the robot system has an objective to hold object 900. Based on this, the second state is determined as a state where end effector 910 will hold object 900 effectively. In the exemplary first state shown in FIG. 9A, end effector 910 is not holding object 900, but is rather touching object 900 with the tip of finger-shaped member 940. In the second state shown in FIG. 9B, end effector 910 is positioned under object 900 (to support the weight of object 900 with palm-shaped member 920), while being oriented and configured to grasp object 900 with finger-shaped members 930 and 940 (and other finger-shaped members not explicitly labelled).

After determining the first and second states of the end effector 910 in accordance with acts 504 and 506 of method 500, a first transformation trajectory is determined for end effector 910 to transform from the first state to the second state, as in act 508 of method 500. In the example of FIGS. 9A and 9B, end effector 910 needs to move from being adjacent object 900 to being under object 900, end effector 910 needs to rotate such that object 900 rests atop palm-shaped member 920, and end effector 910 needs to change configuration to wrap finger-shaped members 930 and 940 (and other unlabeled finger-shaped members) around object 900. In some implementations, movement (displacement) and orientation (rotation) of end effector 910 may be achieved by movement of one or more actuatable members to which end effector 910 is physically coupled, whereas changes to the configuration of end effector 910 may be achieved by actuation(s) of one or more actuatable member(s) of end effector 910 itself (e.g., by actuation(s) of palm-shaped member 920 and/or finger-shaped members 930 and/or 940). Thus, a first transformation trajectory is determined whereby end effector 910 is moved to be positioned, rotated to be oriented, actuated to be configured, or otherwise posed as shown in FIG. 9B.

After determining the first transformation trajectory as in act 508, the at least one processor of the robot system controls end effector 910 to transform from the first state in FIG. 9A to the second state in FIG. 9B in accordance with the first transformation trajectory, as in act 510 of method 500. That is, the at least one processor sends control signals or instructions to any appropriate motors, rotors, or other actuation hardware to cause transformation of end effector 910 in accordance with the first transformation trajectory.

In the illustrated example, movement of end effector 910 can be caused at least partially by actuation of an actuatable member attached thereto. In the illustrated example, end effector 910 is connected to an arm-shaped member 990, and movement of end effector 910 can be at least partially caused by actuation of the arm-shaped member 990. In particular, determining the first state of the end effector as in act 504 of method 500 can include determining the first state as a state of the end effector (hand) 910 and the actuatable member (arm-shaped member 990). Further, determining the first transformation trajectory for the end effector to transform the end effector from the first state to the second state as in act 508 of method 500 can include determining the first transformation trajectory for the end effector and for the actuatable member, to transform the end effector from the first state to the second state. Further still, controlling the end effector to transform in accordance with the first transformation trajectory as in act 510 of method 500 can include controlling the end effector (hand) 910 and the actuatable member (arm-shaped member 990) to transform in accordance with the first transformation trajectory.

In some implementations, determining the second state for the end effector to engage the object as in act 506 of method 500 can include determining the second state as a state of the end effector (hand) 910 and the actuatable member (arm-shaped member 990) for the end effector to engage the object. However, this is not necessarily the case, and in some implementations the first transformation trajectory for the end effector and the actuatable member is determined agnostic to a second state of the actuatable member to which the end effector is physically coupled. That is, in some implementations, the state which the actuatable member ends up in after the transformation in act 510 is not important, as long as the end effector ends up in the desired second state.

The above discussion of actuatable members, determining states and transformation trajectories thereof, and controlling such actuatable members, is applicable to any of the exemplary scenarios and implementations discussed herein, and is not limited to the example of FIGS. 9A and 9B.

The example of FIGS. 9A and 9B is an example where the first state comprises a first position, a first orientation, a first configuration, and/or a first pose of the end effector (hand) 910, and the second state comprises a second position, second orientation, a second configuration, and/or a second pose of the end effector 910 different from the first position, first orientation, first configuration, and/or pose. In this example, determining a transformation trajectory to transform the end effector 910 from the first state to the second state comprises determining a movement trajectory to move the end effector 910 from the first position to the second position, determining a rotation trajectory to rotate the end effector 910 from the first orientation to the second orientation, and determining an actuation trajectory to actuate the end effector 910 from the first configuration to the second configuration. That is, in the example of FIGS. 9A and 9B, the first transformation trajectory comprises a combined trajectory which encompasses movement (similar to as discussed with reference to FIGS. 7A and 7B), rotation (similar to as discussed with reference to FIGS. 8A and 8B), and configuration (similar to as discussed with reference to FIGS. 6A and 6B). In this example, at 510 in method 500, controlling the end effector to transform from the first state to the second state comprises controlling the end effector 910 to move from the first position to the second position, to rotate from the first orientation to the second orientation, and to actuate from the first configuration to the second configuration.

While FIGS. 9A and 9B illustrate transformation of a position, orientation, configuration, and/or pose of an end effector 910, a transformation trajectory is not required to comprise each of position, orientation, and configuration. Rather, a transformation trajectory may comprise any subset of position, orientation, and configuration, as appropriate for a given scenario or implementation. Further, while FIGS. 9A and 9B illustrate a hand-shaped member as the end effector 910, the discussion thereof applies to any appropriate form of end effector.

As mentioned earlier, to determine the first state and the second state of the end effector as in acts 504 and 506 of method 500, the object may first be identified, or attributes of the object may be identified. The extent of identification of the object is implementation and scenario dependent. For instance, in the example of FIGS. 8A and 8B, very little information about button 802 is sufficient (e.g., only the position of button 802), in order for end effector 810 to be accurately transformed to be ready to push button 802. This position information can be captured by a haptic sensor at end effector 810 in act 502 of method 500, or could be captured by any other sensors such as an image sensor of the robot system. In another instance, for the example of FIG. 9A or 9B, more information is helpful about the object 900 in order to determine the first state and or the second state of end effector 910. In particular, dimensions of object 900 are helpful to understand a shape which end effector 910 should assume to grasp object 900. Such dimensional information could be gathered by at least one haptic sensor at end effector 910 (e.g. by end effector 910 touching object 900; more extensive touching will result in more accurate data), or by other sensors, such as an image sensor of the robot system. Alternatively, the object can be identified by at least one classifier (e.g. run on captured image or haptic data), and a digital model of the object can be retrieved from a database based on the resulting classification. Dimensions of the digital model of the object can be identified or retrieved, and the first state and/or second state can be determined based on said dimensions.

Transformation of an end effector does not always occur exactly as planned. For example, components of the end effector may be manufactured with slightly different dimensions or features (e.g., within manufacturing tolerances). As another example, characteristics of an object may not be exactly as identified by sensors of the robot system (or characteristics of an object may not be identified at all, or to a minimal extent). As yet another example, an end effector may be interrupted or altered during movement between states. FIGS. 10A, 10B, 10C, 11A, 11B, 11C, 11D, 12A, 12B, 12C, and 12D discussed below deal with ways for handling such deviations between expected and measured or sensed results.

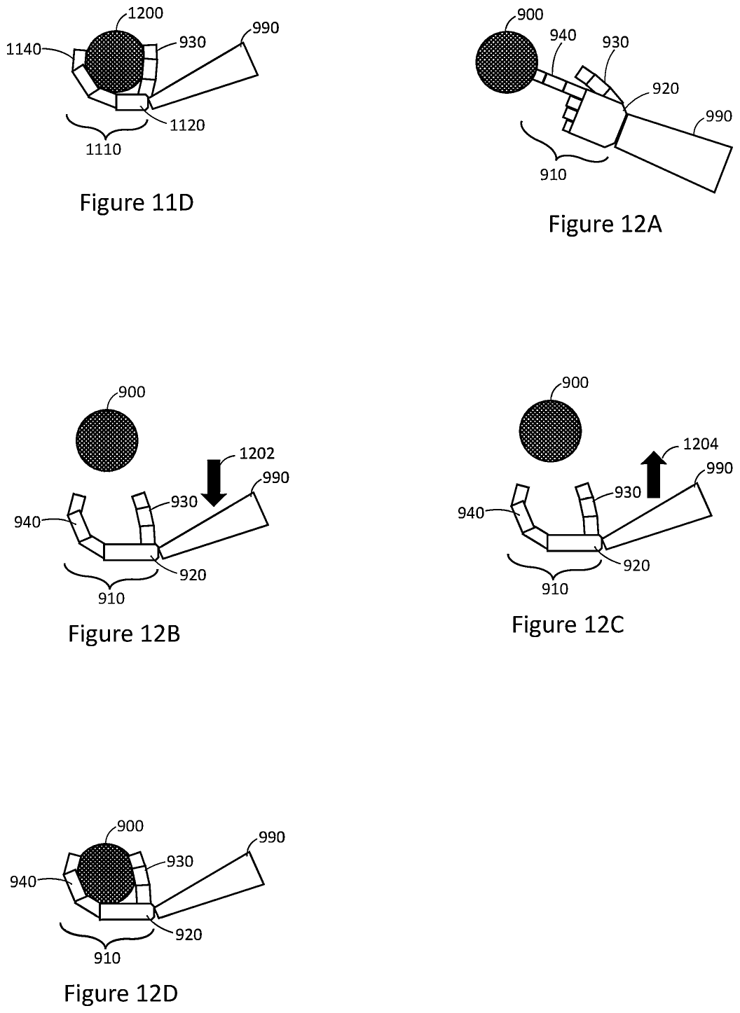

In some implementations and/or scenarios, the second state is updated to accommodate deviations in transformation of the end effector. Optional acts 512, 530, 532, and 534 are shown in method 500 of FIG. 5 for compensation for such deviations, and are discussed below in the context of examples illustrated in FIGS. 10A, 10B, 10C, 11A, 11B, 11C, and 11D.

At 512, the at least one haptic sensor of the robot system captures further haptic data. In some scenarios, this further haptic data can be in response to the end effector further touching the object as the end effector is transformed in accordance with the first transformation trajectory as in act 510 of method 500. In other scenarios, the further haptic data can indicate a lack of touch between the at least one haptic sensor and the object.

At 530, the at least one processor of the robot system determines an updated second state for the end effector to engage the object based at least partially on the further haptic data. At 532, the at least one processor of the robot system determines an updated first transformation trajectory for the end effector to transform the end effector to the updated second state, similarly to as discussed with reference to act 508. At 534, the at least one processor of the robot system controls the end effector to transform to the updated second state in accordance with the updated first transformation trajectory, similarly to as discussed regarding act 510.

FIGS. 10A, 10B, and 10C illustrate an exemplary scenario similar to that illustrated in FIGS. 9A and 9B; description of FIGS. 9A and 9B applies to FIGS. 10A, 10B, and 10C unless context dictates otherwise. In FIG. 10A, a tactile sensor on finger-shaped member 940 of hand 910 (an end effector) collects haptic data for an object 1000 (in accordance with act 502 of method 500). Object 1000 is similar to object 900 in FIGS. 9A and 9B, but object 1000 is oblong instead of spherical. In the example of FIG. 10A, the at least one processor of the robot system identifies a shape of object 1000 incorrectly (or doesn't identify the shape at all), and identifies (or assumes) object 1000 as having spherical shape 1002 (similar to the shape of object 900 in FIGS. 9A and 9B). As a result, the first state, second state, and first transformation trajectory determined in acts 504, 506, and 508 of method 500 are as determined in the example of FIGS. 9A and 9B (that is, the first state of end effector 910 is shown in FIG. 9A, the second state of end effector 910 is shown in FIG. 9B, and the first transformation trajectory is determined to transform end effector 910 from the state shown in FIG. 9A to the state shown in FIG. 9B). When end effector 910 is controlled to transform in accordance with the first transformation trajectory (as in act 510 of method 500), the at least one haptic sensor captures further haptic data (in accordance with act 512 of method 500) in response to end effector 910 further touching object 1000 (as end effector 910 transforms). As shown in FIG. 10B, end effector 910 is in a configuration where tips of finger-shaped members 930 and 940 do not contact object 1000, in contrast to what is expected in the second state shown in FIG. 9B. Haptic sensors in the tips of finger-shaped members 930 and 940 collect further haptic data indicating this lack of contact between finger-shaped members 930 and 940, and object 1000. Based at least partially on the further haptic data, an updated second state of end effector 910 is determined by the at least one processor of the robot system, as shown in FIG. 10C (in accordance with act 530 of method 500). In FIG. 10C, finger-shaped members 930 and 940 wrap more tightly around object 1000 (compared to how these finger-shaped members are positioned in the second state shown in FIG. 9B). Further, the at least one processor of the robot system determines an updated first transformation trajectory (or a second transformation trajectory) for the end effector 910, to transform the end effector 910 to the updated second state (in accordance with act 532 of method 500). The updated first transformation trajectory may specify transformation from the present state of the end effector 910 (i.e. the state where the most recent further haptic data as captured in act 512), which in some scenarios may be an intermediate state between the first state and the originally determined second state; or in some scenarios may be the originally determined second state. Further still, the at least one processor of the robot system controls the end effector 910 to transform to the updated second state in accordance with the updated first transformation trajectory (as in act 534 of method 500).

FIGS. 11A, 11B, 11C, and 11D illustrate an exemplary scenario similar to that illustrated in FIGS. 9A and 9B; description of FIGS. 9A and 9B applies to FIGS. 11A, 11B, 11C, and 11D unless context dictates otherwise. FIGS. 11A, 11B, 11C, and 11D show an end effector 1110 (a hand), which is similar to end effector 910 in FIGS. 9A and 9B; description of components of end effector 910 is applicable to components with similar labels of end effector 1110. In FIG. 11A, a tactile sensor on finger-shaped member 1140 of end effector 1110 (similar to finger-shaped member 940 of end effector 910 in FIGS. 9A and 9B) collects haptic data for an object 900, similar to as in FIGS. 9A and 9B (in accordance with act 502 in method 500). In the example of FIGS. 11A-11D, end effector 1110 includes palm-shaped member 1120, which is similar to palm-shaped member 920 in FIGS. 9A and 9B, but smaller. This difference in size can be the result of manufacturing tolerances or errors. Further, the difference in size of palm-shaped member 1120 results in a different position of finger-shaped member 1140 (the position of finger-shaped member 940 is shown in dashed lines in FIG. 10B for comparison). As a result, the first state, second state, and first transformation trajectory determined in acts 504, 506, and 508 of method 500 are as determined in the example of FIGS. 9A and 9B. That is, the first state of end effector 1110 is similar to that of hand 910 as shown in FIG. 9A; the second state of end effector 1110 is similar to that of hand 910 as shown in FIG. 9B, and the first transformation trajectory is intended to transform end effector 1110 from the first state similar to as shown in FIG. 9A to the second state similar to as shown in FIG. 9B). As shown in FIG. 11B, end effector 1110 is shown partway in the transformation between the first state and the second state (as controlled according to act 510 of method 500), in a configuration where finger-shaped members 930 and 1140 are not open wide enough to grasp object 900, in contrast to what is expected in the second state shown in FIG. 9B (due to the smaller size of palm-shaped member 1120 compared to palm-shaped member 920). Haptic sensors in the tips of finger-shaped members 930 and 1140 collect further haptic data (in accordance with act 512 of method 500) indicating contact between finger-shaped members 930 and 1140, and object 900. Based at least partially on the further haptic data, an updated second state for hand 1110 is determined by the at least one processor of the robot system (in accordance with act 530 of method 500), as shown in FIG. 11D. In FIG. 11D, finger-shaped members 930 and 1140 are open more widely to accommodate object 900 (compared to in FIG. 11B). Further, the at least one processor of the robot system determines an updated first transformation trajectory (or a second transformation trajectory) for end effector 1110 (in accordance with act 532 of method 500), to transform end effector 1110 to the updated second state (from the present state of end effector 1110, illustrated in the example in FIG. 11B). Further still, the at least one processor of the robot system controls the end effector 1110 to transform to the updated second state in accordance with the updated first transformation trajectory (as in act 534 of method 500). FIG. 11C illustrates an intermediate state of end effector 1110, where finger-shaped members 930 and 1140 are opened wider (compared to in FIG. 11B), to accommodate object 900, as part of the transformation to the updated second state shown in FIG. 11D.

In some implementations and/or scenarios, deviations are compensated for by repeating control instructions or reaffirming control to transform the end effector to the determined second state. Acts 512, 520, and 522 in method 500 in FIG. 5 are directed to compensating for deviations in this way, and are discussed below in the context of an example scenario illustrated in FIGS. 12A, 12B, 12C, and 12D.

At 512, the at least one haptic sensor of the robot system captures further haptic data. In some scenarios, this further haptic data can be in response to the end effector further touching the object as the end effector is transformed in accordance with the first transformation trajectory as in act 510 of method 500. In other scenarios, the further haptic data can indicate a lack of touch between the at least one haptic sensor and the object (e.g., where a detected touch is/was expected).

At 520, the at least one processor of the robot system identifies at least one deviation by the end effector from the first transformation trajectory based at least partially on the further haptic data. At 522, the at least one processor of the robot system controls the end effector to correct the deviation by controlling the end effector to transform towards the second state, similarly to as discussed regarding act 510.

FIGS. 12A, 12B, 12C, and 12D illustrate an exemplary scenario similar to that illustrated in FIGS. 9A and 9B; description of FIGS. 9A and 9B applies to FIGS. 12A, 12B, 12C, and 12D unless context dictates otherwise. In FIG. 12A, a tactile sensor on finger-shaped member 940 of end effector 910 (a hand-shaped member) collects haptic data for an object 900 in accordance with act 502 in method 500, similar to as in FIGS. 9A and 9B. Further, the first state, second state, and first transformation trajectory are determined in acts 504, 506, and 508 of method 500 similar to as in the example of FIGS. 9A and 9B. In the example of FIGS. 12A-12D, during transformation of end effector 910 to the second state in accordance with act 510 of method 500, end effector 910 is bumped, struck, or otherwise interrupted by force 1202. As a result, end effector 910 is knocked away from the first transformation trajectory determined in act 508 of method 500. When end effector 910 is knocked by force 1202, the at least one haptic sensor captures further haptic data (as in act 512 of method 500). As shown in FIG. 11B, hand 910 is shown displaced from object 900, due to force 1202. Haptic sensors in the tips of finger-shaped members 930 and 940 collect further haptic data indicating lack of contact between finger-shaped members 930 and 940, and object 900. Based at least partially on this further haptic data, the at least one processor of the robot system identifies at least one deviation of end effector 910 from the first transformation trajectory (e.g. displacement from the first transformation trajectory), as in act 520 of method 500. End effector 910 is then controlled by the at least one processor of the robot system to correct the at least one deviation by controlling the end effector 910 to transform towards the second state originally determined (as in act 522 of method 500), as shown in FIG. 9B. In some implementations, the at least one deviation is determined as a second transformation trajectory to transform the end effector back to the path of the first transformation trajectory (i.e. to undo the deviation). This is shown in FIG. 12C as transformation trajectory 1204, according to which the end effector 910 is controlled to move to undo the deviation. After undoing the deviation, the at least one processor continues to control the end effector 910 to transformation in accordance with the first transformation trajectory to arrive at the originally determined second state as shown in FIG. 11D. In other implementations, after deviation of the end effector 910, identification of the at least one deviation as in act 520 of method 500 further includes determining an updated transformation trajectory, to transform the end effector 910 from the deviated state to the originally determined second state. In the illustrated example, a transformation trajectory is determined to transform end effector 910 from the state shown in FIG. 12B to the state shown in FIG. 12D. The at least one processor of the robot system then controls the end effector 910 to transform to the second state in accordance with the newly determined transformation trajectory as in act 522 of method 500.

In FIG. 5, two alternate optional strategies for compensating for deviations are described (acts 520 and 522 being one strategy, and acts 530, 532, and 534 being another strategy). These strategies could be implemented separately (i.e., a given implementation of a robot system uses only one of these strategies), or could be implemented together (i.e. a given implementation of a robot system is capable of both strategies). When implemented together, the at least one processor of the robot system can perform a determination based on the further haptic data which strategy is most appropriate. In the illustrated examples, the strategy of acts 520 and 522 is appropriate when transformation of the end effector is altered or interrupted by an external force (as in FIGS. 12A-12D). This is because the second state is not inherently inadequate, but rather that the end effector is impeded in getting there. On the other hand, the strategy of acts 530, 532, and 534 is appropriate when the second state should be updated (e.g., the second state as originally determined is inadequate or not optimal, or something prevents the end effector from arriving at the originally determined second state). In the event the strategy of acts 520 and 522 is used and fails (e.g. the end effector is interrupted by a persistent obstacle), the robot system can proceed with the strategy of acts 530, 532, and 534.

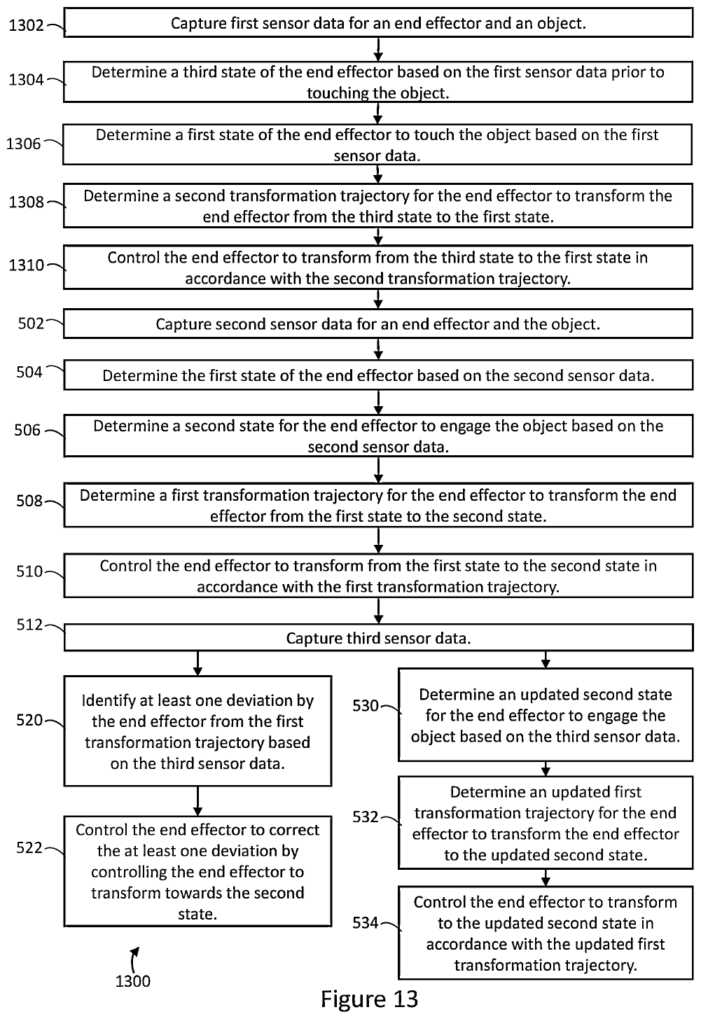

As mentioned earlier, in addition to haptic data from at least one haptic sensor, additional sensor data from additional sensor types can be useful. In this regard, FIG. 13 discussed below is a flowchart diagram which illustrates an exemplary method 1300 of operating a robot system, where sensor data of different types is captured by different sensor types. Method 1300 is similar to method 500 discussed with reference to FIG. 5, and description of method 500 is applicable to method 1300 unless context dictates otherwise. Method 1300 pertains to operation of a robot system, which includes at least one processor, a plurality of sensors (which can include any of haptic/tactile, image, audio, proprioceptive, or other appropriate types of sensor), and at least one end effector. The robot system can also include at least one non-transitory processor-readable storage medium storing data and/or processor-executable instructions that, when executed by the at least one processor, cause the robot system to perform the method 1300. In the exemplary implementations discussed hereafter, the system comprises a robot, which includes a robot body such as those illustrated in FIGS. 1, 2, and 3, and optionally can include a remote device such as that illustrated in FIG. 3. Certain acts of a method of operation of a robot system may be performed by at least one processor or processing unit (hereafter “processor”) positioned at the robot body, and communicatively coupled to a non-transitory processor-readable storage medium positioned at the robot body. The robot body may communicate, via communications and networking hardware communicatively coupled to the robot body's at least one processor, with remote systems and/or remote non-transitory processor-readable storage media, as discussed above with reference to FIG. 3. Thus, unless the specific context requires otherwise, references to a robot system's processor, non-transitory processor-readable storage medium, as well as data and/or processor-executable instructions stored in a non-transitory processor-readable storage medium, are not intended to be limiting as to the physical location of the processor or non-transitory processor-readable storage medium in relation to the robot body and the rest of the robot hardware. In other words, a robot system's processor or non-transitory processor-readable storage medium may include processors or non-transitory processor-readable storage media located on-board the robot body and/or non-transitory processor-readable storage media located remotely from the robot body, unless the specific context requires otherwise. Further, a method of operation of a system such as method 1300 (or any of the other methods discussed herein) can be implemented as a robot control module or computer program product. Such a robot control module or computer program product is data-based, and comprises processor-executable instructions or data that, when the robot control module or computer program product is stored on a non-transitory processor-readable storage medium of the system, and the robot control module or computer program product is executed by at least one processor of the system, the robot control module or computer program product (or the processor-executable instructions or data thereof) cause the system to perform acts of the method.

Method 1300 as illustrated includes acts 1302, 1304, 1306, 1308, 1310, 502, 504, 506, 508, 510, 512, 520, 522, 530, 532, and 534, though those of skill in the art will appreciate that in alternative implementations certain acts may be omitted and/or additional acts may be added. For example, acts 520, 522, 530, 532, and 534 are optional acts that can be omitted as appropriate for a given application. Those of skill in the art will also appreciate that the illustrated order of the acts is shown for exemplary purposes only and may change in alternative implementations. As mentioned above, method 1300 in FIG. 13 is similar to method 500 in Figure, and as such method 1300 includes several acts with the same reference labels as method 500. Description of such acts with reference to FIG. 500 is fully applicable to the corresponding acts in method 1300. There are slight variations in wording in certain acts of method 1300 which are also shown in method 500, but the description of these acts in method 500 is still applicable to the corresponding acts in method 1300; the variations in wording are for consistency with the other acts of method 1300.

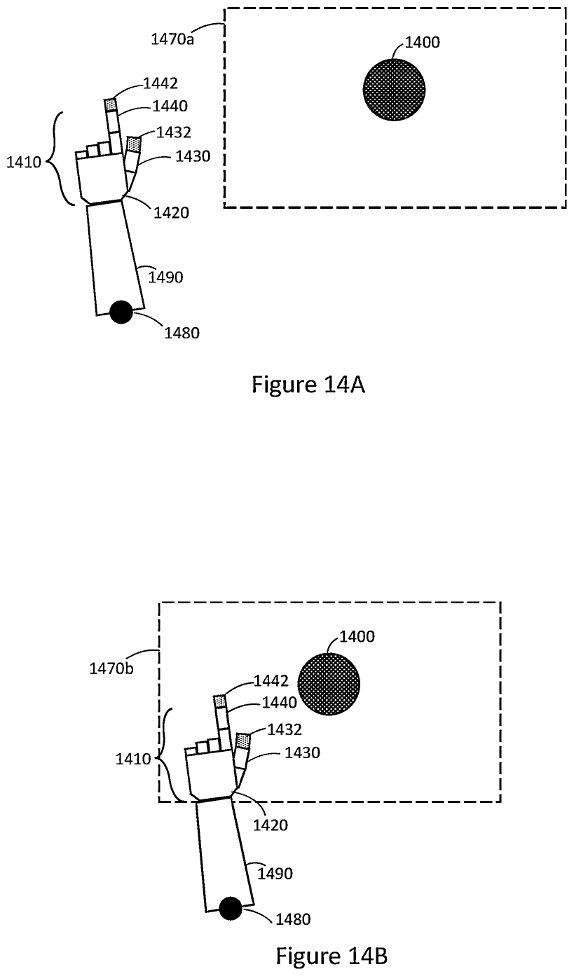

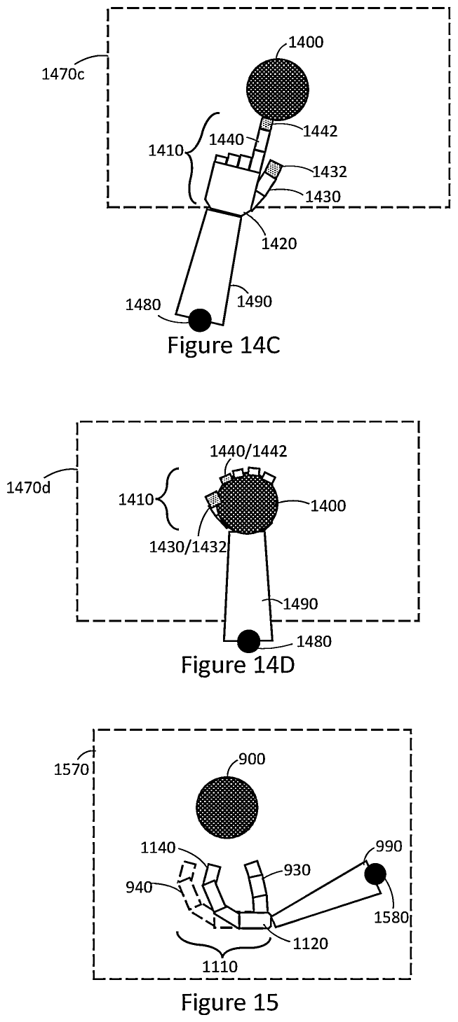

For clarity, method 1300 is discussed in the context of an example scenario shown in FIGS. 14A, 14B, 14C, and 14D. The scenario of FIGS. 14A-14D is merely exemplary, and method 1300 can be applied in any appropriate scenario. FIGS. 14A-14D show an object 1400, which is to be or is engaged by an end effector 1410. End effector 1410 can be similar to end effector 410 discussed with reference to FIGS. 4A, 4B, and 4C, or any of the other end effectors discussed herein. To reduce clutter, not every component or feature of end effector 410 is shown or explicitly labelled for end effector 1410, but such components or features can be included in end effector 1410 as appropriate in a given application. End effector 1410 is shown as including a palm-shaped member 1420, finger-shaped member 1430 having a haptic sensor 1432 thereon, and finger-shaped member 1440 having a haptic sensor 1442 thereon. End effector 1410 is shown as being attached to an actuatable member 1490, which can actuate to cause transformation of end effector 1410. A proprioceptive sensor 1480 is shown attached to actuatable member 1490; such a proprioceptive sensor (or additional proprioceptive sensors) can be positioned anywhere appropriate in the robot system, including in or on end effector 1410. The robot system can also include an image sensor (such as images sensors 120, 121, 220, or 312 in FIGS. 1, 2, and 3) which captures image data (such as image data 1470a, 1470b, 1470c, and 1470d shown in FIGS. 14A, 14B, 14C, and 14D).

Returning to method 1300, acts 1302, 1304, 1306, 1308, and 1310 are directed towards guiding an end effector to an object, prior to initiation of method 500 as shown in FIG. 5. FIGS. 14A, 14B, and 14C illustrate an example of this process.

At 1302, first sensor data is captured for an end effector and an object. FIGS. 14A and 14B illustrate alternative scenarios in what can be represented in this captured first sensor data. In FIG. 14A, the image sensor captures image data 1470a which includes a representation of object 1400, but not of end effector 1410. In this example, proprioceptive sensor 1480 captures proprioceptive data indicative of end effector 1410 (and can be indicative of actuatable member 1490, depending on placement of the proprioceptive sensor). In the example of FIG. 14B, the image sensor captures image data 1470b which includes a representation of object 1400 and a representation of end effector 1410. Optionally, the proprioceptive sensor 1480 captures proprioceptive data indicative of end effector 1410 (and can be indicative of actuatable member 1490, depending on placement of the proprioceptive sensor).

In some implementations, in particular where image sensor data is used but also optionally where only haptic data is used, the systems and methods for implementing object permanence in a simulated environment described in U.S. Provisional Patent Application Ser. No. 63/392,621, which is incorporated herein by reference in its entirety, may advantageously be employed.

At 1304, the at least one processor of the robot system determines a third state of the end effector based on the first sensor data. For consistency with method 500, the terms “first state” and “second state” are reserved for later acts. In this sense, the “third state” refers to a state prior to the end effector touching the object, the “first state” occurs after the third state and refers to a state where the end effector initially touches the object, and the “second state” occurs after the first state and refers to a state where the end effector is transformed to engage the object in a desired manner. With reference to FIGS. 14A and 14B, based on the first sensor data (the image data 1470a or 1470b, and the proprioceptive data if applicable), a third state (position, orientation, configuration, and/or pose) of end effector 1410 is determined prior to touching the object 1400. Thus, throughout this specification and the appended claims, the terms “first”, “second”, and “third” are used only as distinguishing identifiers to distinguish like elements (e.g., states) from one another and should not be construed as indicating any particular order, sequence, chronology, or priority for the corresponding elements.

At 1306, the at least one processor of the robot system determines the first state of the end effector to touch the object based on the first sensor data (e.g. image data 1470a or 1470b, or the proprioceptive data). The first state is shown in FIG. 14C, and in the context of act 1306 refers to a state to transform the end effector 1410 to touch the object 1400 such that haptic data can be captured. At 1306, determination of the first state is predictive (speculative), as the end effector has not actually touched the object yet.

At 1308, the at least one processor of the robot system determines a second transformation trajectory for the end effector to transform the end effector from the third state to the first state. The term “first transformation trajectory” is reserved for use later, for consistency with method 500 described earlier. As examples for the second transformation trajectory, the at least one processor can determine a difference in position between the end effector in the third state and in the first state, and determine a movement trajectory to move the end effector over the difference in position; the at least one processor can determine a difference in orientation between the end effector in the third state and in the first state, and determine a rotation trajectory to rotate the end effector over the difference in orientation; and/or the at least one processor can determine a difference in configuration between the end effector in the third state and in the first state, and determine an actuation trajectory to actuate the end effector over the difference in configuration (e.g., from a first configuration to a second configuration). Description of determining the first transformation trajectory above with reference to act 508 in method 500 is generally applicable to determining the second transformation trajectory.

At 1310, the at least one processor of the robot system controls the end effector to transform from the third state to the first state in accordance with the second movement trajectory. Description of controlling the end effector to transform with reference to act 510 in method 500 is generally applicable to controlling the end effector to transform in act 1310 in act 1300, and is not repeated for brevity.

In the example of FIGS. 14A, 14B, 14C, and 14D, after act 1310, end effector 1410 is in the first state as illustrated in FIG. 14C, where end effector 1410 touches object 1400. From here, method 1300 proceeds similarly to method 500 discussed earlier.

At 502 in method 1300, second sensor data is captured for the end effector and the object. This is similar to act 502 in method 500, where haptic data is captured in response to the end effector touching the object. In addition to haptic data, in method 1300 image data 1470c can be captured by an image sensor of the robot system, and/or proprioceptive data can be captured by proprioceptive sensor 1480.

At 504 in method 1300, the first state of the end effector is determined (again) based on the second sensor data, by the at least one processor of the robot system. This is similar to act 504 in method 500, where the first state of the end effector is determined at least partially based on the haptic data. In addition to the haptic data, determination of the first state in method 1300 can be further based on image data 1470c and/or proprioceptive data captured by proprioceptive sensor 1480. As is illustrated in method 1300, the first state of the end effector is determined at 1306 and again at 504. Determination of the first state at 1306 may be predictive; that is, the first state determined at 1306 may be a goal state, or a state which the robot system aims to transform the end effector to. On the other hand, determination of the first state at 504 may be determination of an actual state of the end effector; that is, the first state determined at 504 may represent an actual measured/detected position, orientation, configuration, and/or pose of end effector 1410. Determination of the first state at 504 can act as a confirmation (namely, that the end effector was correctly controlled in act 1310 to arrive at the first state determined at 1306). Alternatively, determination of the first state at 504 can be an update to the first state as determined in act 1306 (i.e., the actual first state is determined at 504 is different from, and is an update to, the predictive first state determined at 1306) due to some discrepancy between expected and measured state parameters.

At 506 in method 1300, a second state for the end effector to engage the object based on the second sensor data is determined by the at least one processor of the robot system. This is similar to act 506 in method 500, where the second state of the end effector is determined at least partially based on the haptic data. In addition to the haptic data, determination of the second state in method 1300 can be further based on image data 1470c and/or proprioceptive data captured by proprioceptive sensor 1480. FIG. 14D illustrates the second state of end effector 1410, with finger members 1430 and 1440 wrapped around and grasping object 1400.

As discussed earlier, an object can be identified, or attributes of an object can be identified, to more accurately determine the states of the end effector (which includes the third state, first state, and second state of the end effector). The extent of identification of the object is implementation and scenario dependent. For instance, in the example of FIGS. 14A, 14B, 14C, and 14D, it is helpful to have substantial information about the object 1400 in order to determine at least the second state of end effector 1410. In particular, dimensions of object 1400 are helpful to understand a shape or configuration which end effector 1410 should assume to grasp object 1400. Such dimensional information could be gathered by at least one haptic sensor at end effector 1410 (e.g. by end effector 1410 touching object 900; more extensive touching will result in more accurate data, e.g., as described in U.S. Provisional Patent Application Ser. No. 63/351,274, which is incorporated by reference herein in its entirety); but in the context of available data in FIG. 14C, image data 1470a, 1470b, or 1470c can be used to identify the object 1400 or attributes of the object 1400 without relying on additional touching of the object 1400 by end effector 1410. For example, the at least one processor of the robot system can run dimensional analysis on image data 1470a, 1470b, and/or 1470c to determine dimensions of object 1400. Alternatively, the object 1400 can be identified by at least one classifier run on the image data, and a digital model of the object 1400 can be retrieved from a database based on a resulting classification. Dimensions of the digital model of the object can be identified or retrieved, and the first state and/or second state can be determined based on said dimensions.

At 508 in method 1300, a first transformation trajectory for the end effector to transform the end effector from the first state to the second state is determined by the at least one processor of the robot system. This is similar to act 508 in method 500. In the examples of FIGS. 14A-14D, the first transformation trajectory for the end effector is determined to transform end effector 1410 from the state shown in FIG. 14C to the state shown in FIG. 14D.

At 510 in method 1300, the end effector is controlled to transform from the first state to the second state in accordance with the first transformation trajectory. This is similar to act 510 in method 500. In the examples of FIGS. 14A-14D, the end effector 1410 is controlled to transform from the state shown in FIG. 14C to the state shown in FIG. 14D.

Method 1300 as illustrated also includes optional acts 512, 520, 522, 530, 532, and 534. As mentioned above, method 1300 in FIG. 13 is similar to method 500 in Figure, and as such method 1300 includes several acts with the same reference labels as method 500. Description of acts 512, 520, 522, 530, 532, and 534 with reference to FIG. 500 is fully applicable to the corresponding acts in method 1300. There are slight variations in wording in certain acts of method 1300 which are also shown in method 500, but the description of these acts in method 500 is still applicable to the corresponding acts in method 1300; the variations in wording are for consistency with the other acts of method 1300.

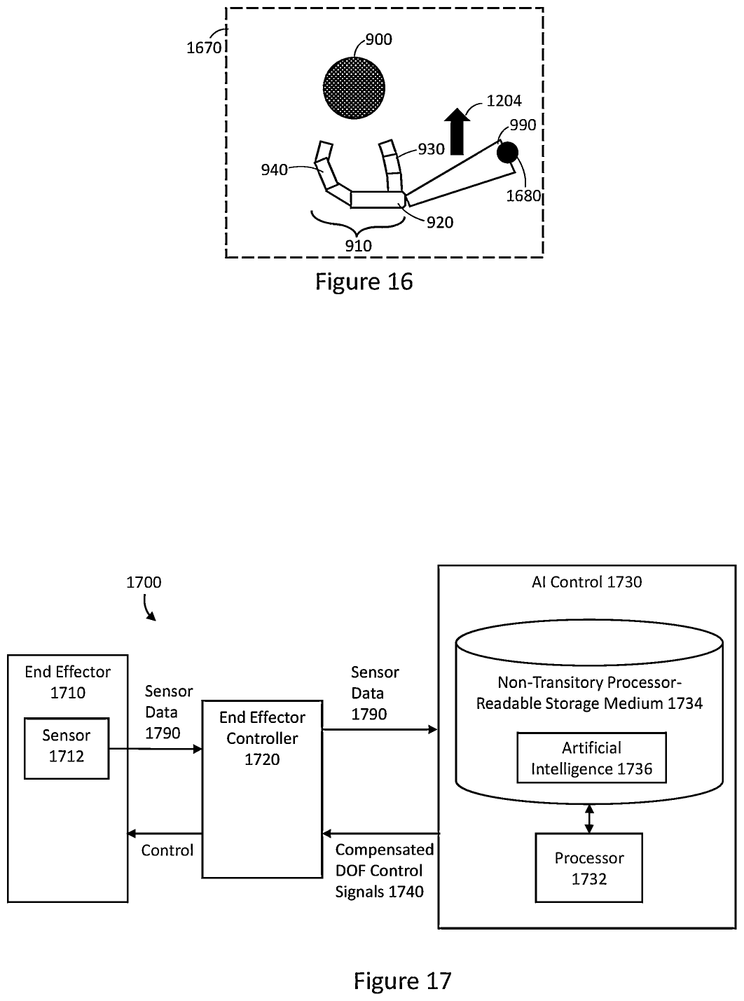

For clarity, acts 512, 520, 522, 530, 532, and 534 of method 1300 are discussed in the context of example scenarios shown in FIGS. 15 and 16. In particular, FIGS. 15 and 16 discussed below illustrate exemplary scenarios where image data and/or proprioceptive data are used in the context of method 1300 to compensate for deviations in transformation of the end effector. The description of acts 512, 520, 522, 530, 532, and 534, and FIGS. 15 and 16, is also fully applicable to method 500 discussed with reference to FIG. 5. The scenarios of FIGS. 15 and 16 are merely exemplary, and method 1300 can be applied in any appropriate scenario.

FIG. 15 illustrates end effector 1110, similar to as in the example of FIGS. 11A, 11B, 11C, and 11D discussed above. Discussion of FIGS. 11A, 11B, 11C, and 11D applies to FIG. 15 unless context dictates otherwise. In particular, FIG. 15 illustrates a similar example to FIGS. 11A, 11B, 11C, and 11D where there is a deviation in transformation of end effector 1110, where finger-shaped members 1140 and 930 are too close together to grasp object 900, because palm-shaped member 1120 is smaller than palm-shaped member 920 of end effector 910. FIG. 15 illustrates a similar moment to that shown in FIG. 11B, where end effector 1110 is partway through transformation to the second state. In the example of FIG. 15, end effector 1110 is not touching object 900, and thus it is difficult to determine relative positioning of object 900 to end effector 1110 based on haptic data alone, such that it is also difficult to determine an updated first transformation trajectory as in act 532 of method 500. Additional sensor data is useful in this scenario, as is discussed in the context of method 1300.

FIG. 15 also shows image data 1570, captured by at least one image sensor of the robot system (such as those discussed with reference to FIG. 1, 2, or 3). Such image data can be captured in addition to the further haptic data in act 512 of method 500 (or together as the third sensor data in act 512 of method 1300). Image data 1570 is shown as including a representation of end effector 1110 (the end effector in method 1300 in this example), and a representation of object 900 (the object in method 1300 in this example). At 530 of method 1300, based on the third sensor data which includes the further haptic data (which indicates that end effector 1110 is not touching object 900 in the example) and the image data (showing relative positions, configurations, and orientations of end effector 1110 and object 900 in the example), the at least one processor of the robot system determines an updated second state for the end effector 1110 to engage object 900 (similar to as in act 530 of method 500, but based on additional sensor data). At 532 of method 1300, the at least one processor of the robot system then determines an updated first transformation trajectory for the end effector 1110 to transform the end effector 1110 to the updated second state (similar to as in act 532 of method 500 discussed earlier). At 534 of method 1300, the at least one processor of the robot system controls the end effector 1110 to transform in accordance with the updated first transformation trajectory (similar to as in act 534 of method 500 discussed earlier).

FIG. 15 also shows proprioceptive sensor 1580 (such as those discussed with reference to FIG. 1), which captures proprioceptive data. Such proprioceptive data can be captured in addition to the further haptic data captured in act 512 of method 500 (or together as the third sensor data in act 512 of method 1300). Such proprioceptive data can be indicative of a position, configuration, orientation, pose, or movement of end effector 1110. At 530 of method 1300, based on the third sensor data which includes the further haptic data (which indicates that end effector 1110 is not touching object 900 in the example) and the proprioceptive data (indicative of a position of end effector 1110 in the example), the at least one processor of the robot system determines an updated second state for the end effector 1110 to engage object 900 (similar to as in act 530 of method 500, but based on additional sensor data). At 532 of method 1300, the at least one processor of the robot system then determines an updated first transformation trajectory for the end effector 1110 to transform the end effector to the updated second state (similar to as in act 532 of method 500 discussed earlier). At 534 of method 1300, the at least one processor of the robot system controls the end effector 1110 to transform in accordance with the updated first transformation trajectory (similar to as in act 534 of method 500 discussed earlier).

In some implementations, further haptic data can be captured as discussed above, image data can be captured as discussed above, and proprioceptive data can be captured as discussed above. In such implementations, determining the updated second state as in act 530 of method 1300 is based on the further haptic data, the image data, and the proprioceptive data (together as the third sensor data). In this way, compensation for deviations is performed based on several types of data from several types of sensors.

FIG. 16 illustrates end effector 910, similar to as in the example of FIGS. 12A, 12B, 12C, and 12D discussed above. Discussion of FIGS. 12A, 12B, 12C, and 12D applies to FIG. 16 unless context dictates otherwise. In particular, FIG. 16 illustrates a similar example to FIGS. 12A, 12B, 12C, and 12D where there is a deviation in transformation of end effector 910, where end effector 910 is knocked away or displaced from object 900. FIG. 16 illustrates a similar moment to that shown in FIG. 12C, where end effector 910 is partway through transformation to the second state, and a deviation from the first transformation trajectory is in the process of being addressed. In the example of FIG. 16, end effector 910 is not touching object 900, and thus it is difficult to determine relative positioning of object 900 to end effector 910 based on haptic data alone, such that it is also difficult to identify at least one deviation by end effector 910 from the first transformation trajectory as in act 520 of method 500. Additional sensor data is useful in this scenario, as discussed in the context of method 1300.

FIG. 16 also shows image data 1670, captured by at least one image sensor of the robot system (such as those discussed with reference to FIG. 1, 2, or 3). Such image data can be captured in addition to the further haptic data captured in act 512 of method 500 (or together as the third sensor data in act 512 of method 1300). Image data 1670 is shown as including a representation of end effector 910 (the end effector in method 1300 in this example), and a representation of object 900 (the object in method 1300 in this example). At 520 in method 1300, based on the third sensor data which includes the further haptic data (which indicates that end effector 910 is not touching object 900 in the example) and the image data (showing relative positions, orientations, configurations, and/or poses of end effector 910 and object 900 in the example), the at least one processor of the robot system identifies at least one deviation by end effector 910 from the first transformation trajectory (similar to as in act 520 of method 500, but based on additional sensor data). At 522 in method 1300, the at least one processor of the robot system can then control the end effector 910 to correct the at least one deviation (similar to as in act 522 of method 500 discussed earlier).

FIG. 16 also shows proprioceptive sensor 1680 (such as those discussed with reference to FIG. 1), which captures proprioceptive data. Such proprioceptive data can be captured in addition to the further haptic data captured in act 512 of method 500 (or together as the third sensor data in act 512 of method 1300). Such proprioceptive data can be indicative of a position, configuration, orientation, pose, or movement of end effector 910. At 520 of method 1300, based on the third sensor data which includes the further haptic data (which indicates that end effector 910 is not touching object 900 in the example) and the proprioceptive data (indicative of a position of end effector 910 in the example), the at least one processor of the robot system identifies at least one deviation by end effector 910 from the first transformation trajectory (similar to as in act 520 of method 500, but based on additional sensor data). At 522 in method 1300, the at least one processor of the robot system can then control the end effector 910 to correct the at least one deviation (as in act 522 of method 500 discussed earlier).

In some implementations, further haptic data can be captured as discussed above, image data can be captured as discussed above, and proprioceptive data can be captured as discussed above (together as the third sensor data). In such implementations, identifying the at least one deviation as in act 520 of method 1300 is based on the further haptic data, the image data, and the proprioceptive data. In this way, compensation for deviations is performed based on several types of data from several types of sensors.

As mentioned earlier, acts of methods 500 and 1300 can be performed by components of a system which are included at a robot body of the system, or by components of the system which are remote from the robot body of the system (e.g. included on a remote device of the system). For example, acts performed by at least one processor of the system can be performed by a processor at the robot body or a processor at the remote device. Likewise, data can be stored at a non-transitory processor-readable storage medium at the robot body, or a non-transitory processor-readable storage medium at the remote device. Further, the acts of methods 500 and 1300 do not have to performed exclusively by components at the robot body or components at the remote device. Rather, some acts can be performed by components at the robot body, and some acts can be performed by components at the remote device, within a given implementation. Any appropriate data can be transmitted between the robot body and the remote device, by at least one communication interface as described with reference to FIG. 3, to enable the robot body and the remote device to perform desired acts. Reference to data transmissions between a robot body and a remote device by a communication interface refer to communication hardware at the robot body and communication hardware at the remote device interacting, packaging, or interpreting signals as appropriate to transmit the data. In one non-limiting exemplary implementation, acts 1302, 1304, 1306, 1310, 502, 504, 506, 510, 512, 520, 522, 530, and 534 are performed by respective components at the robot body, whereas acts 1308, 508, and 532 are performed by respective components at the remote device. In this implementation, state data indicating any determined state of the end effector is transmitted from the robot body to the remote device via the communication interface, and trajectory data indicating any determined transformation trajectory is transmitted from the remote device to the robot body via the communication interface. In another non-limiting exemplary implementation, acts 1302, 502, and 512 (related to capturing sensor data) are performed by respective components at the robot body, whereas acts 1304, 1306, 1308, 1310, 504, 506, 508, 510, 520, 522, 530, 532, and 534 are performed by respective components at the remote device. In this exemplary implementation, any captured sensor data can be transmitted by the communication interface from the robot body to the remote device, and control of the end effector of the robot body can be performed by transmitting control instructions from the remote device to the robot body via the communication interface. In yet another non-limiting exemplary implementation, all of acts 1302, 1304, 1306, 1308, 1310, 502, 504, 506, 508, 510, 512, 520, 522, 530, 532, and 534 are performed by respective components at the robot body.

FIG. 17 is a schematic view of another exemplary implementation of a robot system 1700. Robot system 1700 can be a part of any other robot systems described herein (such as those described with reference to FIGS. 1, 2, and 3).

Robot system 1700 is shown as includes at least one end effector 1710. End effector 1710 can correspond to any other end effectors described herein, such as end effectors 116 and 117 in FIGS. 1, end effector 214 in FIG. 2, an end effector coupled to actuatable member 310 in FIG. 3, end effector 410 in FIG. 4A, 4B, 4C, or any other end effector described herein. In FIG. 17, at least one sensor 1712 is shown as being coupled to end effector 1710. The at least one sensor 1712 could for example include a haptic sensor, such as haptic sensors 124 and 125 in FIG. 1, haptic sensors 221 in FIG. 2, haptic sensors 314 in FIG. 3, tactile sensors 422, 432, or 442 in FIG. 4A, or any other haptic sensor described herein.

Robot system 1700 as shown also includes an end effector controller 1720, which causes actuation of end effector 1710. For example, end effector controller 1720 can include any appropriate actuators, motors, rotors, or other actuation hardware which cause motion of components of end effector 1710. Alternatively, end effector controller 1720 can be a control unit which sends control signals to separate actuation hardware to cause motion of components of end effector 1710. End effector controller 1720 can control at least some of the degrees of freedom (DOFs) of end effector 1710. Controlling “degrees of freedom” refers to the ability of the end effector controller 1710 to control movement, rotation, and/or configuration of an end effector. For example, movement in position of the end effector 1710 along x, y, and z axes constitutes control of the end effector in 3 degrees of freedom. As another example, rotation of the end effector 1710 around x, y, and z axes constitutes control of the end effector in another 3 degrees of freedom. As yet another example, actuation of components of the end effector 1710 relative to other components of the end effector 1710 constitutes control of the end effector 1710 in as many degrees of freedom as the respective components are capable of actuation.

Robot system 1700 as shown also includes an AI control 1730. AI control 1730 can be (or be part of) a robot controller, such as robot controller 130 in FIG. 1, robot controller 230 in FIG. 2, or a robot controller which includes any of processors 302 and/or 352, and non-transitory processor-readable storage mediums 304 and/or 354 in FIG. 3. AI control 1730 in FIG. 17 is also shown as including at least one processor 1732 and at least one non-transitory processor-readable storage medium 1734 communicatively coupled to each other. The at least one non-transitory processor-readable storage medium 1734 stores an artificial intelligence 1736 thereon. Artificial intelligence 1736 can comprise any data, instructions, routines, algorithms, models, control paradigms, or other information which when executed by the at least one processor 1710 cause the AI control 1730 to output control data or instructions.

In FIG. 17, sensor 1712 generates or captures sensor data 1790 (e.g. haptic data, in response to end effector 1710 touching an object). This sensor data 1790 is provided to end effector controller 1720, which in turn provides the sensor data 1790 to AI control 1730. In alternative implementations, the at least one sensor 1712 can provide the sensor data 1790 to the AI control directly, or via another module.

In the example illustrated in FIG. 17, artificial intelligence 1736 provides end effector DOF control signals 1740. The end effector DOF control signals 1740 are configured to reach a goal in a configuration of the end effector 1710 (e.g., with reference to FIGS. 5 and 13, the DOF control signals are configured to transform end effector 1710 in accordance with a transformation trajectory to a goal state, such as the second state). Further, the DOF control signals 1740 are compensated for variation in the end effector DOFs based on the haptic data. Compensation for variations is similar to compensating for deviations, as discussed earlier with reference to FIGS. 5, 10A, 10B, 10C, 11A, 11B, 11C, 11D, 12A, 12B, 12C, 12D, 13, 15, and 16. Implementations for compensating for variations in the context of FIG. 17 are described later.

End effector controller 1720 receives the compensated DOF control signals 1740 from AI control 1730, and controls actuation of end effector 1710 based thereon. In some examples, actuators, motors, rotors, or other actuation hardware of end effector controller 1720 operate in accordance with the compensated DOF control signals 1740, to actuate end effector 1710. In other examples, end effector controller 1720 converts the compensated DOF control signals into direct control signals, which are in turn provided to actuators, motors, rotors, or other actuation hardware which cause end effector 1710 to actuate in accordance with the direct control signals.

Several different strategies or methodologies can be implemented to compensate for variations in the context of robot system 1700.

In some implementations, the end effector DOF control signals being compensated for variations in the end effector DOFs entails the end effector DOFs being compensated for variations between expected DOFs of the end effector 710, as expected by the end effector controller 1720 based on control instructions the end effector controller executes to control the end effector 1710, and actual DOFs of the end effector 1710 determined based on sensor data 1790. That is, actuation of end effector 1710 may not result in the end effector 1710 being positioned, rotated, or configured exactly as expected by end effector controller 1720. This could occur for reasons discussed with reference to FIGS. 11A, 11B, 11C, and 11D, in that elements of end effector 1710 may not be exactly identical to as expected by end effector controller 1720. Elements of end effector 1710 may be different in size or shape due to manufacturing tolerances or errors, for example. Alternatively, parameter drift or control system errors may result in end effector 1710 not being positioned, rotated, or configurated exactly as expected. In this exemplary implementation, over time artificial intelligence 1736 can be trained or otherwise learn at least one compensation factor which represents consistent variation between expected DOFs of the end effector 1710 as expected by end effector controller 1720, and actual DOFs of the end effector 1710, based on sensor data (such as haptic data) captured by the at least one sensor 1712. Once the at least one compensation factor is at least partially learned, AI control 1730 can compensate for variations in end effector 1710 DOFs by applying the at least one compensation factor. For example, if end effector is consistently 2 mm different from expectation in a particular direction, a compensation factor of −2 mm in this direction can be learned, and applied to DOF control signals for the end effector 1710, resulting in compensated DOF control signals.

In other implementations, the end effector DOF control signals being compensated for variations in the end effector DOFs entails the end effector DOF control signals being compensated for variations in the end effector DOFs caused by properties of the object. Such variations can arise for reasons such as those discussed with reference to FIGS. 10A, 10B, and 10C, where the object has different properties (dimensions, in the illustrated example) than expected. As a result, end effector 1710 may not engage with the object exactly as expected. To address this, as end effector 1710 touches the object and sensor 1712 collects haptic data, a haptic model is generated based on the haptic data by the end effector controller 1720 (or could be generated by artificial intelligence 1736 and/or the at least one processor 1732), which represents the object (for example, dimensions, textures, and features of the object). The haptic model is applied by the artificial intelligence 1736 (e.g. via the at least one processor 1732) to compensate for variations in the end effector DOFs. That is, by using a haptic model of the object (generated based on accurate data), precise DOF control instructions are generated which instruct how the end effector 1710 should engage the object. In this way, variations between what the object is expected to be are “compensated” for using the model of how the object actually is. Robots, robot systems, and methods for generating haptic models or profiles are discussed in U.S. Provisional Patent Application No. 63/351,274, the entirety of which is incorporated by reference herein.

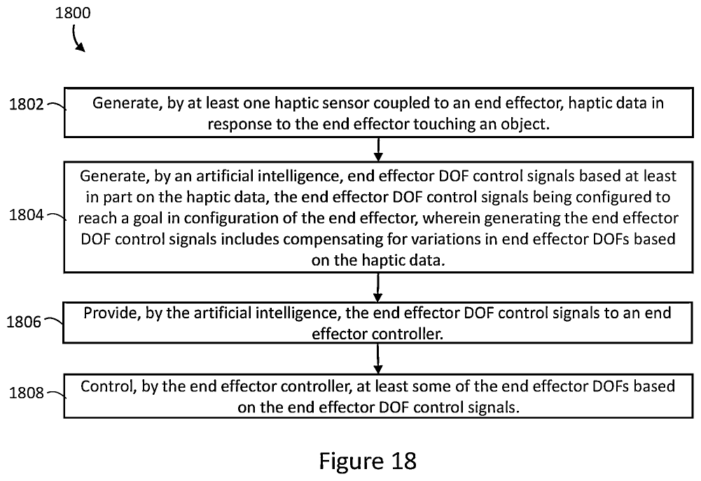

FIG. 18 discussed below is a flowchart diagram which illustrates an exemplary method 1800 of operating a robot system, such as robot system 1700 in FIG. 17. Generally, discussion of robot system 1700 above, and operation thereof, is applicable to method 1800 unless context dictates otherwise. The robot system 1700 can also include at least one non-transitory processor-readable storage medium storing data and/or processor-executable instructions that, when executed by at least one processor of the robot system, cause the robot system to perform the method 1800. Certain acts of method 1800 may be performed by at least one processor positioned at a robot body, and communicatively coupled to a non-transitory processor-readable storage medium positioned at the robot body. The robot body may communicate, via communications and networking hardware communicatively coupled to the robot body's at least one processor, with remote systems and/or remote non-transitory processor-readable storage media, as discussed above with reference to FIG. 3. Thus, unless the specific context requires otherwise, references to a robot system's processor, non-transitory processor-readable storage medium, as well as data and/or processor-executable instructions stored in a non-transitory processor-readable storage medium, are not intended to be limiting as to the physical location of the processor or non-transitory processor-readable storage medium in relation to the robot body and the rest of the robot hardware. In other words, a robot system's processor or non-transitory processor-readable storage medium may include processors or non-transitory processor-readable storage media located on-board the robot body and/or non-transitory processor-readable storage media located remotely from the robot body, unless the specific context requires otherwise. Further, a method of operation of a system such as method 1800 (or any of the other methods discussed herein) can be implemented as a robot control module or computer program product. Such a robot control module or computer program product is data-based, and comprises processor-executable instructions or data that, when the robot control module or computer program product is stored on a non-transitory processor-readable storage medium of the system, and the robot control module or computer program product is executed by at least one processor of the system, the robot control module or computer program product (or the processor-executable instructions or data thereof) cause the system to perform acts of the method.

Method 1800 as illustrated includes acts 1802, 1804, 1806, and 1808, though those of skill in the art will appreciate that in alternative implementations certain acts may be omitted and/or additional acts may be added.

At 1802, at least one haptic sensor coupled to an end effector (e.g. sensor 1712 coupled to end effector 1710 in robot system 1700) generates haptic data in response to the end effector touching an object (similarly to as discussed above with reference to FIG. 17).

At 1804, an artificial intelligence (e.g. artificial intelligence 1736 in robot system 1700) generates end effector DOF control signals based at least in part on the haptic data generated at 1802. The end effector DOF control signals are configured to reach a goal in configuration of the end effector (e.g., with reference to FIGS. 5 and 13, the DOF control signals are configured to transform the end effector in accordance with a transformation trajectory to a goal state, such as the second state, similar to as described for robot system 1700). Generating the end effector DOF control signals at 1804 includes compensating for variation in end effector DOFs based on the haptic data, such as in examples discussed earlier with reference to FIG. 17 and discussed later.

At 1806, the artificial intelligence provides the end effector DOF control signals to an end effector controller (e.g., artificial intelligence provides compensated DOF control Signals 1740 to end effector controller 1720 as shown in FIG. 17, and as discussed earlier).

At 1808, the end effector control controls at least some of the end effector DOFs based on the end effector control signals (e.g. end effector controller 1720 controls at least some of the DOFs of end effector 1710 based on the compensated DOF control signals as shown in FIG. 17, and as discussed earlier).

Several different strategies or methodologies can be implemented to compensate for variations in the context of method 1800. For example, the strategies and methods to compensate for variations as discussed above in the context of robot system 1700 are also applicable to method 1800. In some implementations, compensating for variations in end effector DOFs based on the haptic data in act 1804 comprises: compensating, by the artificial intelligence 1736, the end effector DOF control signals for variations between expected DOFs of the end effector 1710 as expected by the end effector controller 1720 based on control instructions the end effector controller 1720 executes to control the end effector 1710, and actual DOFs of the end effector 1710 determined based on the haptic data (sensor data 1790), similarly to as discussed with reference to robot system 1700.

As another example, compensating for variations in end effector DOFs based on the haptic data in act 1804 comprises: compensating for variations in the end effector DOFs caused by one or more of system errors, parameter drift, or manufacturing tolerances, similar to as discussed earlier with reference to robot system 1700.

As yet another example, compensating the end effector DOFs for variations between expected DOFs of the end effector 1710 as expected by the end effector controller 1720 based on control instructions the end effector controller 1720 executes to control the end effector 1710, and actual DOFs of the end effector 1710 determined based on the haptic data, comprises: learning, by the artificial intelligence 1736, at least one compensation factor which represents consistent variations between expected DOFs of the end effector 1710 as expected by the end effector controller 1720 and actual DOFs of the end effector 1710 determined based on the haptic data (sensor data 1790), independent of the object; and applying, by the artificial intelligence 1736, the at least one compensation factor to compensate for variations in the end effector DOFs. Learning and applying a compensation factor is similar to as discussed earlier with reference to robot system 1700.

As yet another example, compensating for variations in end effector DOFs based on the haptic data comprises: compensating the end effector DOF control signals for variations in the end effector DOFs caused by properties of the object.

As yet another example, compensating the end effector DOFs for variations between expected DOFs of the end effector 1710 as expected by the end effector controller 1720 based on control instructions the end effector controller 1720 executes to control the end effector 1710, and actual DOFs of the end effector 1710 determined based on the haptic data (sensor data 1970), comprises: generating a haptic model by the end effector controller 1720 which represents the object, based on the haptic data; and applying, by the artificial intelligence 1736, the haptic model to compensate for variations in the end effector DOFs. Generation and application of a haptic model is similar to as discussed earlier with reference to robot system 1700.

The robot systems described herein may, in some implementations, employ any of the teachings of U.S. patent application Ser. No. 16/940,566 (Publication No. US 2021-0031383 A1), U.S. patent application Ser. No. 17/023,929 (Publication No. US 2021-0090201 A1), U.S. patent application Ser. No. 17/061,187 (Publication No. US 2021-0122035 A1), U.S. patent application Ser. No. 17/098,716 (Publication No. US 2021-0146553 A1), U.S. patent application Ser. No. 17/111,789 (Publication No. US 2021-0170607 A1), U.S. patent application Ser. No. 17/158,244 (Publication No. US 2021-0234997 A1), US Patent Publication No. US 2021-0307170 A1, and/or US Patent Publication US 2022-0034738 A1, as well as U.S. Non-Provisional patent application Ser. No. 17/749,536, U.S. Non-Provisional patent application Ser. No. 17/833,998, U.S. Non-Provisional patent application Ser. No. 17/863,333, U.S. Non-Provisional patent application Ser. No. 17/867,056, U.S. Non-Provisional patent application Ser. No. 17/871,801, U.S. Non-Provisional patent application Ser. No. 17/976,665, U.S. Provisional Patent Application Ser. No. 63/392,621, and/or U.S. Provisional Patent Application Ser. No. 63/342,414, each of which is incorporated herein by reference in its entirety, each of which is incorporated herein by reference in its entirety.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present robots, robot systems and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. (canceled)

2. (canceled)

3. (canceled)

4. (canceled)

5. The computer-implemented method of claim 21, wherein the robot system further comprises at least one image sensor, and the method further comprises, prior to capturing the initial haptic data by the at least one haptic sensor:
capturing, by the at least one image sensor, image data including a representation of the object;
determining, by the at least one processor, a third state of the end effector prior to the at least one haptic sensor initially touching the object;
predicting, by the at least one processor, the first state for the end effector to enable the at least one haptic sensor to initially touch the object;
determining, by the at least one processor, a second transformation trajectory to transform the end effector from the third state to the first state; and
controlling, by the at least one processor, the end effector to transform the end effector from the third state to the first state in accordance with the second transformation trajectory.

6. The computer-implemented method of claim 5, wherein:
capturing image data including the representation of the object comprises: capturing image data including the representation of the object and the representation of the end effector; and
determining the third state of the end effector comprises determining the third state of the end effector based at least partially on the image data.

7. The computer-implemented method of claim 6, wherein determining the first state of the end effector based at least in part on the initial haptic data comprises determining the first state of the end effector based at least partially on the image data and the initial haptic data.

8. The computer-implemented method of claim 5, wherein:
the robot system further comprises at least one proprioceptive sensor;
the method further comprises capturing, by the at least one proprioceptive sensor, proprioceptive data for the end effector; and
determining the third state of the end effector comprises determining the third state of the end effector relative to the object based at least partially on the proprioceptive data.

9. The computer-implemented method of claim 8, wherein determining the first state of the end effector based at least in part on the initial haptic data comprises determining the first state of the end effector based at least partially on the proprioceptive data and the initial haptic data.

10. The computer-implemented method of claim 22, wherein:
the robot system further comprises at least one image sensor;
the method further comprises capturing, by the at least one image sensor, image data including a representation of the object and a representation of the end effector; and
determining the first state of the end effector based at least in part on the initial haptic data comprises determining the first state based on the initial haptic data and the image data.

11. The computer-implemented method of claim 10, wherein the operations further comprise:
capturing, by the at least one image sensor, further image data including a further representation of the object and a further representation of the end effector;
wherein the at least one deviation is determined based on the further haptic data and the further image data.

12. The computer-implemented method of claim 10, wherein the operations further comprise:
capturing, by the at least one image sensor, further image data including a further representation of the object and a further representation of the end effector; and
wherein determining the at least one update to the first transformation trajectory based at least in part on the further haptic data comprises determining, by the at least one processor, an updated second state for the end effector to grasp the object based at least partially on the further haptic data and the further image data;
wherein the updated transformation trajectory transforms the end effector to the updated second state.

13. The computer-implemented method of claim 21, wherein:
the first state of the end effector comprises a first position of the end effector;
the second state of the end effector comprises a second position of the end effector different from the first position;
determining the first transformation trajectory to transform the end effector from the first state to the second state comprises: determining a movement trajectory to move the end effector from the first position to the second position; and
controlling the one or more degrees of freedom of the end effector to transform the end effector according to the first transformation trajectory comprises: controlling the end effector to move the end effector from the first position to the second position in accordance with the movement trajectory.

14. The computer-implemented method of claim 21, wherein:
the first state of the end effector comprises a first orientation of the end effector;
the second state of the end effector comprises a second orientation of the end effector different from the first orientation;
determining the first transformation trajectory to transform the end effector from the first state to the second state comprises: determining a rotation trajectory to move the end effector from the first orientation to the second orientation; and
controlling the one or more degrees of freedom of the end effector to transform the end effector according to the first transformation trajectory comprises: controlling the end effector to rotate the end effector from the first orientation to the second orientation in accordance with the rotation trajectory.

15. The computer-implemented method of claim 21, wherein:
determining the first transformation trajectory to transform the end effector from the first state to the second state comprises: determining a first actuation trajectory to actuate the end effector from the first configuration to the second configuration; and
controlling the one or more degrees of freedom of the end effector to transform the end effector according to the first transformation trajectory comprises: controlling the end effector to actuate the end effector from the first configuration to the second configuration in accordance with the first actuation trajectory.

16. (canceled)

17. (canceled)

18. (canceled)

19. (canceled)

20. (canceled)

21. A computer-implemented method of operating a robot system including an end effector having multiple degrees of freedom, at least one haptic sensor coupled to the end effector, and at least one processor, the method comprising:
in response to the at least one haptic sensor initially touching an object, capturing initial haptic data by the at least one haptic sensor;
determining, by the at least one processor, a first state of the end effector based at least in part on the initial haptic data, the first state comprising a first configuration of the end effector;
determining, by the at least one processor, one or more attributes of the object;
determining, by the at least one processor, a second state of the end effector to grasp the object based on the one or more attributes of the object and an objective, wherein the second state comprises a second configuration of the end effector that is different from the first configuration;
determining, by the at least one processor, a first transformation trajectory to transform the end effector from the first state to the second state;
controlling, by the at least one processor, one or more degrees of freedom of the end effector to transform the end effector according to the first transformation trajectory;
while controlling the one or more degrees of freedom of the end effector to transform the end effector according to the first transformation trajectory, performing operations comprising:
capturing further haptic data by the at least one haptic sensor;
determining, by the at least one processor, at least one update to the first transformation trajectory based at least in part on the further haptic data;
applying the at least one update to the first transformation trajectory to generate an updated first transformation trajectory; and
resuming controlling the one or more degrees of freedom of the end effector based on the updated first transformation trajectory.

22. The computer-implemented method of claim 21, wherein determining the at least one update to the first transformation trajectory based at least in part on the further haptic data comprises determining at least one deviation of the end effector from a path of the first transformation trajectory based at least in part on the further haptic data.

23. The computer-implemented method of claim 22, wherein determining the at least one update to the first transformation trajectory based at least in part on the further haptic data comprises determining a current state of the end effector based at least in part on the further haptic data and determining the at least one update to the first transformation trajectory to transform the end effector from the current state to the second state.

24. The computer-implemented method of claim 22, wherein determining the at least one update to the first transformation trajectory based at least in part on the further haptic data comprises determining a current state of the end effector based at least in part on the further haptic data, determining an update to the second state based at least in part on the further haptic data, and determining the at least one update to the first transformation trajectory to transform the end effector from the current state to the updated second state.

25. The computer-implemented method of claim 22, wherein the further haptic data indicates a lack of touch between the at least one haptic sensor and the object.

26. The computer-implemented method of claim 22, wherein the further haptic data indicates a further touch between the at least one haptic sensor and the object subsequent to the at least one haptic sensor initially touching the object.

27. The computer-implemented method of claim 21, wherein the one or more attributes of the object are determined based at least in part on the initial haptic data.

28. The computer-implemented method of claim 21, further comprising capturing, by at least one image sensor, image data including a representation of the object and the end effector, wherein the one or more attributes of the object are determined based at least in part on the initial haptic data and the image data.

29. The computer-implemented method of claim 21, further comprising capturing, by at least one image sensor, image data including a representation of the object, wherein the one or more attributes of the object are determined based at least in part on the image data.
